(19) United States
(12) Patent Application Publication
(10) Pub. No.: US 2023/0333051 A1
(43) Pub. Date: Oct. 19, 2023

(54) SCALABLE APPARATUSES AND MODELS FOR DETERMINING ANALYTICALLY EFFICIENT TRANSFER CURVE PARAMETERS FOR SENSOR ICS WITH 2D FIELD EFFECT TRANSISTORS

(71) Applicant: Cardea Bio, Inc., San Diego, CA (US)

(72) Inventors: Brett Goldsmith, San Diego, CA (US); Jonathan Parkinson, San Diego, CA (US); Kiana Aran, Pasadena, CA (US); Alexander Kane, Santa Cruz, CA (US)

(21) Appl. No.: 18/319,347

(22) Filed: May 17, 2023

Related U.S. Application Data
(63) Continuation of application No. 18/174,418, filed on Feb. 24, 2023.
(60) Provisional application No. 63/343,019, filed on May 17, 2022.
(60) Provisional application No. 63/314,270, filed on Feb. 25, 2022.

(51) Int. Cl. G01N 27/414

(52) U.S. Cl. CPC G01N 27/4148; G01N 27/4145; G01N 27/4146

(57) ABSTRACT

An apparatus may include a memory storing transfer curve information for the 2D FETs obtained by applying bias conditions including a drain-to-source voltage and a gate-to-source voltage to the 2D FETs, and measuring channel currents for the 2D FETs while varying the gate-to-source voltage of the 2D FETs. An apparatus may include a characterization parameter encoder that determines the one or more output characterization parameters as output data of a machine learning model by applying the transfer curve information for the 2D FETs as input data to the machine learning model, wherein the machine learning model has been trained to output the one or more output characterization parameters of the fit function for an input of the transfer curve information for the 2D FETs. A system and methods for training and using the machine learning model are disclosed.

### CROSS REFERENCE TO RELATED APPLICATIONS

The present application is a continuation-in-part of, and claims priority to U.S. application 18/174,418 filed Feb. 24, 2023, with the title “Integrated Circuit Chip With 2D Field-Effect Transistors And On-Chip Thin Film Layer Deposition With Electrical Characterization” which claims priority from provisional application 63/314,270 filed Feb. 25, 2022, with the title “Integrated Circuit Chip With 2D Field-Effect Transistors And On-Chip Thin Film Layer Deposition With Electrical Characterization.” The present application also claims priority to U.S. provisional application 63/343,019 filed on May 17, 2022, with the title “Integrated Circuit with 2D Field Effect Transistors and Connected Analysis Modules for Determining Transfer Curve Parameters in Real-Time.” The aforementioned applications are incorporated herein by reference in their entireties to the extent legally allowable.

### FIELD

The subject matter disclosed herein relates to integrated circuits with 2D field effect transistor arrays, and more particularly relates to scalable apparatuses and models for determining analytically efficient transfer curve parameters of sensor ICs with 2D field effect transistors.

### BACKGROUND

Two-dimensional field effect transistors (“2D FETs”) such as graphene field effect transistors or gFETs are useful as sensors to detect target substances or interactions in a fluid. With the liquid applied in contact with a 2D field effect transistor channel, substances or interactions occurring sufficiently close to the channel may gate the current through the channel.

A transfer curve for a 2D FET, such as a gFET, may illustrate or represent the dependence of the drain current on a voltage applied to the liquid gate. Thus, if substances or interactions gate the current through the channel, the shape of the transfer curve for a 2D FET (e.g., a gFET) when a target substance is present, or when an interaction occurs, may be different from the shape of the transfer curve when a target substance is absent, or when an interaction does not occur. Thus, detecting changes in the transfer curve for a 2D FET, such as a gFET, may facilitate using the 2D FET to detect a target substance. However, existing approaches to curve-fitting to determine a complex equation or model for a transfer curve of a gFET based on experimentally determined information may be time-consuming or computationally expensive. In some cases, existing approaches to curve fitting may provide a moderately good curve fit but provide limited information that distinctly correlates with characteristics of substances or biochemical interactions of interest.

### SUMMARY

Systems, scalable apparatuses and models for determining analytically efficient transfer curve parameters of sensor ICs with 2D field effect transistors are disclosed.

In various aspects, the techniques described herein relate to an apparatus for determining one or more output characterization parameters of a fit function that models a selected form of transfer curves for an array of 2D field effect transistors (FETs) on a sensor IC for characterizing biochemical interactions occurring within a measurement distance of the 2D FETs, the apparatus including: a memory storing transfer curve information for the 2D FETs obtained by applying bias conditions including a drain-to-source voltage and a gate-to-source voltage to the 2D FETs, and measuring channel currents for the 2D FETs while varying the gate-to-source voltage of the 2D FETs; and a characterization parameter encoder that determines the one or more output characterization parameters as output data of a machine learning model by applying the transfer curve information for the 2D FETs as input data to the machine learning model, where the machine learning model has been trained to produce as outputs the one or more output characterization parameters of the fit function that models the selected form of the transfer curve information for the 2D FETs.

In some aspects, the techniques described herein relate to an apparatus, where the transfer curve information includes a set of data points that associate a set of channel output currents of the 2D FETs measured in response to one or more excitation conditions including a voltage sweep of liquid gate bias voltage applied to a fluid covering the 2D FETs.

In certain aspects, the techniques described herein relate to an apparatus, where the machine learning model includes a feed forward neural network encoder that has been trained to determine a fit function including four or less output characterization parameters curve based on training set data including the transfer curve information that model a form of the transfer curves for the 2D FETs.

In one or more aspects, the techniques described herein relate to an apparatus, where the transfer curve information includes one or more vectors including elements corresponding to 2D FET excitation conditions varied in accordance with a predetermined incrementally varying voltage sweep of a liquid gate bias voltage, and/or a 2D channel input bias voltage varied at a predetermined characteristic resonance frequencies; and further including output elements corresponding to 2D FET output signals generated in response to the 2D FET excitation conditions and to biochemical interactions occurring in the liquid.

In some aspects, the techniques described herein relate to an apparatus, further including a complexity reduction module that produces a reduced complexity form of the transfer curve information by applying one or more operations to the transfer curve information in response to determining that applying the one or more operations continues to satisfy a predetermined goodness of fit requirement.

In various aspects, the techniques described herein relate to an apparatus, where the predetermined goodness of fit requirement is satisfied in response to values output from the machine learning model fitting actual values with a coefficient of determination of 0.98 or greater.

In certain aspects, the techniques described herein relate to an apparatus, where the one or more operations applied by the complexity reduction module are selected from: normalized transfer curve information along an x-axis representing a gate voltage VG by subtracting a charge neutrality point voltage from a measured value VRef of a gate voltage for the transfer curves to align lowest points of the transfer curves at a VG=0 point along an x-axis; normalized transfer curve information along a y-axis representing channel output current to be within a range of from 0 to 1 by determining a minimum value and a maximum value for each instance of channel output current in a set of transfer curve information, subtracting the minimum value from each instance of channel output current in the set of transfer curve information, dividing each instance of channel output current in the set of transfer curve information by the maximum value minus the minimum value; a first derivative of the transfer curve model normalized along x and y axes and including a slope intercept form of a line plus a logistic function with a sigmoid curve and a vertical scaling numerator; a resistance corrected version thereof; and combinations thereof.

In one or more aspects, the techniques described herein relate to an apparatus, where the characterization parameter encoder indicates a biochemical interaction occurring within a measurement distance of the 2D FET based on one or more of: a first output characterization parameter ‘k’ output by the machine learning model which corresponds to one or more slopes of p-type and n-type plateau regions of the sigmoid curve and varies based on total volume of biochemical material interacting with the channel of the 2D FET; a third output characterization parameter ‘A’ output by the machine learning model which corresponds to a vertical scaling numerator of a logistic function term of the first derivative and varies based on ionic strength of a liquid containing the biochemical material; a fourth output characterization parameter ‘w’ output by the machine learning model which corresponds to the slope of logistic function exponential growth region and varies based on a total charge of the biochemical material interacting with the channel of the 2D FETs;

In various aspects, the techniques described herein relate to an apparatus, where the characterization parameter encoder indicates a potential manufacturing anomaly in the 2D FET based on a second output characterization parameter ‘B’ output by the machine learning model which corresponds to a vertical offset in the derivative of a resistance adjusted change in currents.

In some aspects, the techniques described herein relate to a method for determining a machine learning model with a minimized number of output characterization parameters useful for characterizing differences in biochemical interactions occurring in a fluid within a measurement distance of an array of 2D FETs on a sensor IC, the method including: determining a preliminary fit function that satisfies a predetermined goodness of fit requirement for a set of transfer curve information obtained by applying bias conditions including a drain-to-source voltage and a gate-to-source voltage to the 2D FET, and measuring drain currents for the 2D FET while varying the gate-to-source voltage of the 2D FET, where instances of transfer curve information are obtained for a range of respective 2D FETs and a range of respective biological samples applied to the 2D FET; determining a reduced complexity fit function that has fewer linear terms or constants terms than the preliminary fit function by applying one or more complexity reducing operations to the transfer curve information in the set in response to determining that applying the one or more operations continues to satisfy the predetermined goodness of fit requirement; and training a machine learning model to reconstruct transfer curve information that corresponds to expected outputs from the reduced complexity fit function for the transfer curve information within a predetermined reconstruction coefficient of determination.

In certain aspects, the techniques described herein relate to a method, where the predetermined coefficient of determination is 0.98 or greater.

In some aspects, the techniques described herein relate to a method, where the one or more complexity reducing operations include: preparing normalized transfer curve information along an x-axis representing gate voltage by subtracting a charge neutrality point voltage from a gate voltage for the transfer curves to align lowest points of the transfer curves at a VG=0 point along an x-axis; preparing normalized transfer curve information along a y-axis representing channel output current to be within a range of from 0 to 1 by: determining a minimum value and a maximum value for each instance of channel output current in the set of transfer curve information, subtracting the minimum value from each instance of channel output current in the set of transfer curve information, and dividing each instance of channel output current in the set of transfer curve information by the maximum value minus the minimum value; dividing each instance of channel output current in the set of transfer curve information by resistance at the charge neutrality point; and combinations thereof.

In one or more aspects, the techniques described herein relate to a method, where the one or more operations further include: determining a first derivative of the preliminary fit function; and applying the first derivative of the preliminary fit function to the normalized transfer curve information.

In various aspects, the techniques described herein relate to a method, where the minimized number of output characterized parameters for the machine learning model is four or less.

In some aspects, the techniques described herein relate to a method, where: where the output characterization parameters of the machine learning model correspond one or more parameters of a first derivative of a normalized fit function a first output characterization parameter ‘k’ represents a slope of a coefficient of in a linear term of the first derivative that combines with output of a logistic growth function and varies based on total volume of biochemical material interacting with the channel of the 2D FETs; a second output characterization parameter ‘B’ includes a constant term of the first derivative that varies with manufacturing variation of the 2D FETs; third output characterization parameter ‘A’ includes a numerator of a logistic function term of the first derivative and varies based on ionic strength of the fluid containing the biochemical material; a fourth output characterization parameter w includes a logistic growth rate of the logistic function term varies based on a total charge of the biochemical material interacting with the channel of the 2D FETs.

In certain aspects, the techniques described herein relate to a method, where the machine learning model includes a feed forward neural network encoder that is trained to output the one or more output characterization parameters of the reduced complexity fit function for the transfer within a predetermined reconstruction coefficient of determination in response to receiving the 2D FET transfer curve information.

In some aspects, the techniques described herein relate to a method including: providing an integrated circuit (“IC”) including; a sensor array of two-dimensional (“2D”) field effect transistors (“2D FETs”), each 2D FET in the array including: a 2D transistor channel formed in a layer of 2D nanomaterial disposed on a substrate; a gate area for receiving a volume of liquid; a conductive source electrically coupled to a first end of the 2D transistor channel; a conductive drain electrically coupled to a second end of the 2D transistor channel; and an insulating layer disposed over the conductive source and the conductive drain; one or more integrated gate biasing electrodes disposed on the substrate for biasing and/or measuring electrical characteristics of the liquid over gate areas of the array; determining transfer curve information for the 2D FETs of the array by applying bias conditions including a drain-to-source voltage and a gate-to-source voltage, and measuring channel currents for the 2D FETs while varying the gate-to-source voltage; determining one or more output characterization parameters as output data of a machine learning model by applying a reduced complexity form of a fit function that models transfer curves of the 2D FETs to transfer curve information used as input data to the machine learning model, where the machine learning model has been trained to output the one or more output characterization parameters of the reduced complexity form of the fit function in response to receive the 2D FET transfer curve information as input data.

In various aspects, the techniques described herein relate to a method, where the reduced complexity form of the transfer curve information modeled by the machine learning model includes a first derivative of the transfer curve normalized along x and y axes and including a slope intercept form of a line plus a logistic function with a vertical scaling numerator.

In some aspects, the techniques described herein relate to a method, further including characterizing a biochemical interaction occurring within a measurement distance of the 2D FETs based on one or more of: a first output characterization parameter ‘k’ output by the machine learning model which corresponds to one or more slopes of plateau regions of a logistic function including a sigmoid curve and varies based on total volume of biochemical material interacting with the channel of the 2D FET; a third output characterization parameter ‘A’ output by the machine learning model which corresponds to a vertical scaling numerator of a logistic function term of a first derivative and varies based on an ionic strength of the liquid containing the biochemical material; and a fourth output characterization parameter ‘w’ output by the machine learning model which corresponds to the slope of logistic function exponential growth region and varies based on a total charge of the biochemical material interacting with the channel of the 2D FETs.

In certain aspects, the techniques described herein relate to a system including: a data repository; and a plurality of distributed sensor nodes, each sensor node including: an integrated circuit (“IC”) including; a sensor array of two-dimensional field effect transistors (“2D FETs”), each 2D FET in the array including: a 2D transistor channel formed in a layer of 2D material disposed on a substrate; a gate area for receiving a volume of liquid; a conductive source electrically coupled to a first end of the 2D transistor channel; a conductive drain electrically coupled to a second end of the 2D transistor channel; and an insulating layer disposed over the conductive source and the conductive drain; one or more integrated gate biasing electrodes disposed on the substrate for biasing and/or measuring electrical characteristics of the liquid over gate areas of the array; a measurement controller operable to determine transfer curve information for the 2D FETs of the array by applying bias conditions including a drain-to-source voltage and a gate-to-source voltage, and measuring drain currents for the 2D FETs while varying the gate-to-source voltage; a characterization parameter encoder operable to determine a set of output characterization parameters for an equation that models a first derivative of a transfer curve, by applying a machine learning model to the transfer curve information from the measurement controller, where the machine learning model is trained to associate transfer curve information with parameters.

### BRIEF DESCRIPTION OF THE DRAWINGS

In order that the advantages of the invention will be readily understood, a more particular description of the invention briefly described above will be rendered by reference to specific examples that are illustrated in the appended drawings. Understanding that these drawings depict only typical examples of the invention and are not therefore to be considered to be limiting of its scope, the invention will be described and explained with additional specificity and detail through the use of the accompanying drawings, in which:

FIG. 1 is a schematic block diagram illustrating a system with apparatuses for determining and using analytically efficient transfer curve parameters for scalable applications of sensor nodes that include sensor ICs with arrays of 2D FETs, according to one or more examples of the present disclosure;

FIG. 2 is a schematic block diagram illustrating a sensor node with an array of 2D FETs and apparatuses determining and using analytically efficient transfer curve parameters for using the sensor node in a scalable system, according to one or more examples of the present disclosure;

FIG. 3A is an illustration of a typical transfer curve for a liquid gated 2D FET with a graphene channel, according to one or more examples of the present disclosure;

FIG. 3B is an illustration of an output characterization parameters for transfer curve information for a liquid gated 2D FET with a graphene channel, according to one or more examples of the present disclosure;

FIG. 3C is an illustration of a transfer curve differences in charge neutrality point for a liquid gated 2D FET with a graphene channel, according to one or more examples of the present disclosure;

FIG. 3D is an illustration of a transfer curve differences in overall shape and slope for a liquid gated 2D FET with a graphene channel, according to one or more examples of the present disclosure;

FIG. 4 is an illustration an example of certain challenges with 2D FET transfer curve complexity exemplified by recent efforts undertaken by an advanced semiconductor materials and devices groups to develop a compact piecewise model for extracting device parameters capable of fitting 87% of I_{DS} vs V_{GS} curves for electrolytically gated graphene FETs with a mean error of 7% or less;

FIG. 5A is an illustration of a standard form of I-V_{G} curves for a sensor IC with a 2D FET at selected points in an Example Protocol CC1;

FIG. 5B is an illustration of a reduced complexity form of the I-V_{G} curves for FIG. 5A where the transfer curves are normalized to align the Dirac voltage of each curve (voltage at charge neutrality point) at a V_{G}=0 point along an x-axis;

FIG. 5C is an illustration of chart with a further reduced complexity form of the I-V_{G} curves for FIGS. 5A and/or 5B, where the transfer curves are normalized to represent current as a percentage of maximum current along a y-axis;

FIG. 5D is an illustration of a chart where the transfer curves are normalized to correct for resistance to represent current as a percentage increase from the charge neutrality point along the y-axis;

FIG. 6A is an illustration of a chart that models results of transfer curves in a reduced complexity form that is a normalized current version of a first derivative of the I-V_{G} curves for the normalized I-V_{G} curves depicted in FIG. 5C;

FIG. 6B is an illustration of a chart that models results of transfer curves in a reduced complexity form that is a resistance corrected first derivative of the I-V_{G} curves for the normalized I-Vg curves depicted in FIG. 6A;

FIG. 7A is a schematic block diagram illustrating a feed forward neural network used for encoding and decoding output characterization parameters from the reduced complexity form of is a resistance corrected first derivative of the I-V_{G} transfer curves depicted in FIG. 6B;

FIG. 7B is an annotated version of the illustration depicted in FIG. 7A showing four output characterization parameters labeled on the resistance adjusted first derivative form of the transfer curves;

FIG. 8 is a schematic flow chart diagram illustrating a method for determining transfer curve parameters, according to one or more examples of the present disclosure;

FIG. 9 is a schematic flow chart diagram illustrating a method for training a machine learning model to output characterization parameters that model a reduced complexity fit function for a range of 2D FET transfer curves, according to one or more examples of the present disclosure; and

FIG. 10 is a schematic flow chart diagram illustrating another method for determining transfer curve parameters, according to one or more examples of the present disclosure.

### DETAILED DESCRIPTION

Guidance regarding the language of the disclosure.

As will be appreciated by one skilled in the art, aspects of the disclosure may be embodied as a system, method, or program product. Accordingly, examples or implementations may take the form of an entirely hardware implementation, an entirely software implementation (including firmware, resident software, micro-code, etc.) or an implementation combining software and hardware aspects that may all generally be referred to herein as a “circuit,” “module,” or “system.” Furthermore, implementation may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In certain examples, the storage devices only employ signals for accessing code.

Certain of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like. Some modules may be implemented on various nodes which are described below.

Modules may also be implemented in code and/or software for execution by various types of processors. An identified module of code may, for instance, comprise one or more physical or logical blocks of executable code which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for examples may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on a user’s computer, partly on the user’s computer, as a stand-alone software package, partly on the user’s computer, partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider).

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the modules described herein, in certain examples, may alternatively be embodied by or implemented as a component.

A circuit, or circuitry, as used herein, comprises a set of one or more electrical and/or electronic components providing one or more pathways for electrical current. In certain examples, circuitry may include a return pathway for electrical current, so that a circuit is a closed loop. In some examples, however, a set of components that does not include a return pathway for electrical current may be referred to as a circuit or as circuitry (e.g., an open loop). For example, an integrated circuit may be referred to as a circuit or as circuitry regardless of whether the integrated circuit is coupled to ground (as a return pathway for electrical current) or not. In various examples, circuitry may include an integrated circuit, a portion of an integrated circuit, a set of integrated circuits, a set of non-integrated electrical and/or electrical components with or without integrated circuit devices, or the like. In one or more examples, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the modules described herein, in certain examples, may be embodied by or implemented as a circuit.

Reference throughout this specification to “one example,” “an example,” or similar language means that a particular feature, structure, or characteristic described in connection with the example is included in at least one example of the present disclosure. Appearances of the phrases “in one example,” “in an example,” and similar language throughout this specification may, but do not necessarily, all refer to the same example. Similarly, the use of the term “implementation” means an implementation having a particular feature, structure, or characteristic described in connection with one or more examples of the present disclosure, however, absent an express correlation to indicate otherwise, an implementation may be associated with one or more examples.

The described features, structures, advantages, and/or characteristics of the subject matter of the present disclosure may be combined in any suitable manner in one or more examples, including embodiments and/or implementations. In the following description, numerous specific details are provided to impart a thorough understanding of examples of the subject matter of the present disclosure. One skilled in the relevant art will recognize that the subject matter of the present disclosure may be practiced without one or more of the specific features, details, components, materials, and/or methods of a particular example, embodiment, or implementation. In other instances, additional features and advantages may be recognized in certain examples, embodiments, and/or implementations that may not be present in all examples, embodiments, or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims, or may be learned by the practice of the subject matter as set forth hereinafter.

Aspects of the examples are described below with reference to schematic flowchart diagrams and/or schematic block diagrams of methods, apparatuses, systems, and program products according to examples. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatuses, or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods, and program products according to various examples. In this regard, each block in the schematic flowchart diagrams and/or schematic block diagrams may represent a module, segment, or portion of code, which comprises one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding examples. Indeed, some arrows or other connectors may be used to indicate only the logical flow of the depicted example. For instance, an arrow may indicate a waiting or monitoring period of unspecified duration between enumerated steps of the depicted example. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate examples of like elements.

As used herein, a list with a conjunction of “and/or” includes any single item in the list or a combination of items in the list. For example, a list of A, B, and/or C includes only A, only B, only C, a combination of A and B, a combination of B and C, a combination of A and C or a combination of A, B, and C. As used herein, a list using the terminology “one or more of′ includes any single item in the list or a combination of items in the list. For example, one or more of A, B, and C includes only A, only B, only C, a combination of A and B, a combination of B and C, a combination of A and C or a combination of A, B, and C. As used herein, a list using the terminology “one of” includes one and only one of any single item in the list. For example, “one of A, B, and C” includes only A, only B or only C and excludes combinations of A, B, and C. As used herein, “a member selected from the group consisting of A, B, and C,” includes one and only one of A, B, or C, and excludes combinations of A, B, and C. As used herein, “a member selected from the group consisting of A, B, and C and combinations thereof” includes only A, only B, only C, a combination of A and B, a combination of B and C, a combination of A and C or a combination of A, B, and C.

### Definitions

The term “node” as used here refers to a physical or virtual component that is capable of interfacing with a network, unless otherwise clear from context. Some examples of nodes include switches, routers, servers, clients, workstations, laptops, handhelds, printers, hubs, network attached storage devices, and the like. As used herein, the term “node” may also refer to a specific network service or set of network services such as web services, mobile applications, cloud services, whether such services are generally available or are dynamically allocated on demand. A node may be implemented as module that is executed by one or more processors executing code to interface with a network and to perform functions on data communicated over the network.

The term “integrated circuit,” as used herein, refers to a plurality of circuits or circuit components formed on a common substrate. For example, an integrated circuit may include a plurality of transistors. As another example, an integrated circuit may include one or more transistors with peripheral components such as resistors, capacitors, voltage regulators, or the like. Although the term “integrated circuit” is sometimes used in the semiconductor industry to refer to digital circuits such as microprocessors with millions or billions of transistors, the term may refer to digital and/or analog circuits, and to circuits with as few as two components integrated on the same substrate. Examples of a substrate for an integrated circuit include silicon, silicon oxide or another non-conductive substrate formed above a silicon wafer or chip, plastics, fiberglass, polymers, glass, or other conductive or non-conductive substances, which may or may not be silicon-based. Some integrated circuits may be manufactured using layered processing similar to integrated circuit processes for silicon chips, applied with any desired modifications to materials other than silicon chips.

The term “graphene,” as used herein, refers to a single layer of carbon atoms arranged in a two-dimensional (2D) hexagonal lattice. The hexagonal lattice may resemble the hexagonal structure of a honeycomb. A single layer of atoms may be referred to as an “atomic” layer. Minor impurities, lattice defects, or deformations may exist in an atomic layer of carbon, but the resulting structure may nevertheless still be referred to as “graphene.”

The terms “two dimensional field effect transistor” or “2D FET,” or “Cardean transistor” as used herein, refer to a transistor where current between source and drain terminals, through one or more channels comprising a 2D nanomaterial such as graphene, molybdenum disulfide (MoS₂) phosphorene, transition metal dichalcogenides, or similar 2D material, can be modulated by events occurrences, or interactions that affect the output current of the channel(s). In contrast, FETs using carbon nanotubes or other 1D materials as a channel material, or FETS such as silicon ISFETs where the channel is not formed in a two dimensional layer, and graphene sensors that do not exhibit n-type and p-type I-Vg transfer curve responses would not be considered 2D FETs for purposes of this application.

Likewise, although the term “2D field effect transistor” may be sometimes used in industry to refer to entirely solid-state devices where the current flowing through the 2D material channel is modulated via a gate terminal or a body terminal, the 2D field effect transistors disclosed herein are liquid-gated, meaning that current through the 2D material channel(s) is modulated or affected by events, occurrences, or interactions within a liquid in contact with the channel(s). For example, an interaction of ions, molecules, or moieties within the fluid, or an interaction between the channel surface and ions, molecules, or moieties within the fluid, may be capable of gating, modulating, or affecting the channel current. The term “2D field effect transistor” may be used to refer to such a device in use, with a liquid applied to the surface of the channel, or to the same device before the liquid has been applied. The terms “biologically gated transistor,” “environmentally gated transistor,” and/or “biology gated transistor” may also be used to refer to a 2D field effect transistor that is liquid gated as described above.

The terms “graphene field effect transistor” or “gFET,” as used herein, refer to a 2D field effect transistor where current between source and drain terminals, through one or more 2D transistor channels, can be modulated by events, occurrences, or interactions that affect the conductivity of the 2D transistor channel(s). Although the term “graphene field effect transistor” is sometimes used in industry to refer to entirely solid-state devices where the conductivity of the 2D transistor channel is modulated via a gate terminal or a body terminal, the graphene field effect transistors disclosed herein are liquid-gated, meaning that current through the 2D transistor channel(s) is modulated or affected by events, occurrences, or interactions within a liquid in contact with the channel(s). For example, an interaction of ions, molecules, or moieties within the fluid, or an interaction between the channel surface and ions, molecules, or moieties within the fluid, may be capable of gating, modulating, or affecting the channel current. The term “graphene field effect transistor” may be used to refer to such a device in use, with a liquid applied to the surface of the channel, or to the same device before the liquid has been applied.

Furthermore, the term “graphene field effect transistor” or 2D field effect transistor may be used without regard to whether current is modulated by an external power source, the interactions of ions, molecules, or moieties within the applied fluid, or a combination of the two. For example, a graphene field effect transistor or another type of 2D field effect transistor may be gated by an external voltage applied to the liquid in addition to biochemical interactions occurring in the fluid, but may still be referred to as a “gFET or a 2D FET.”

The term “BPU″™ is a trademark for biosignal processing unit ICs and platforms using the 2D field effect transistors and corresponding platforms invented and developed by the inventors of the present subject matter.

The term “output signal,” as used herein, refers to a measurable or detectable electrical signal from an integrated circuit, a 2D FET (e.g., gFET), or an array of 2D FETs (e.g., gFETs), or to a result that can be calculated based on the measurable or detectable signal. For example, an output signal may be a voltage at one or more terminals of an integrated circuit, a current at one or more integrated circuit, a capacitance, inductance, or resistance (calculated based on applied and measured voltages and currents), a complex-valued impedance, a complex impedance spectrum, an electrochemical impedance spectrum, a threshold voltage, a transfer curve, a Dirac voltage, a power spectral density, one or more network parameters (such as S-parameters or h-parameters), or the like.

The term “excitation condition,” as used herein, refers to a physical, electrical, or chemical condition applied to an integrated circuit, a 2D FET (e.g., gFET), or an array of 2D FETs (e.g., gFETs), or to a sample for measurement by an integrated circuit, a 2D FET (e.g., gFET), or an array of 2D FETs (e.g., gFETs). Excitation conditions may affect ions, molecules or moieties in the liquid applied to a 2D FET, such as a gFET, which in turn may affect one or more output signals from the 2D FET. For example, excitation conditions may include voltages, currents, frequencies, amplitudes, phases, or waveforms of electrical signals applied to a 2D FET (e.g., gFET), one or more temperatures, one or more liquid flow rates, one or more wavelengths of electromagnetic radiation, or the like.

Various techniques exist for using liquid-gated 2D FETs, such as gFETs, to detect target substances in a fluid, to monitor events or occurrences near a 2D transistor channel, or the like. An event, occurrence, or interaction near the channel may affect the transfer curve, or the relation of drain current to applied liquid gate voltage, for a 2D FETs (e.g., gFET). Thus, in various applications, characterizing a transfer curve by fitting an equation to the curve may facilitate determining whether the transfer curve was affected by a target substance being present, an interaction occurring, or the like. However, curve-fitting methods for determining coefficients or other parameters for such an equation may be time-consuming or computationally expensive.

The term “distance,” as used herein with reference to a distance from the surface of a channel in a biologically gated transistor, refers to a distance between a point (e.g., in the sample fluid), and the closest point of the channel surface to that point. For example, the distance from the surface of the channel to a point directly above the channel in the sample liquid is the distance between a point on the channel surface to the point in the sample liquid along a line that is normal (perpendicular) to the channel surface.

The term “measurement distance,” as used herein, refers to a distance from the surface of a channel in a liquid gated 2D field effect transistor, such that at least some aspect or portion of a chemical or biochemical interaction occurring at the measurement distance affects an output signal in a way that is detectable by a measurement apparatus. In other words, output signals from a 2D field effect transistor are sensitive to chemical or biochemical events occurring at or within the measurement distance from the surface of a channel. Whether an effect on an output signal is detectable by a measurement apparatus may depend on actual sensitivity of the measurement apparatus, on a noise level for noise in the output signal, the extent to which the output signal is affected by aspects or portion of a chemical or biochemical interaction occurring closer to the channel surface, or the like. Whether an effect on an output signal is detectable by a measurement apparatus may be based on a predetermined threshold for detection or sensitivity, which may be signal to noise ratio, a ratio between effects on the output signal caused by events at a distance from the channel to effects on the output signal caused by events at the channel surface, or the like. In some examples, a measurement distance may depend on excitation conditions, or may be frequency dependent.

The term “electrostatic screening distance” as used herein, refers to a measurement distance for a 2D field effect transistor for steady state (e.g., constant voltage or direct current) or low-frequency (e.g., less than 10 Hz) excitation conditions and measurements. One or more layers of ions may form near the surface of a channel of a 2D field effect transistor when a liquid is applied in contact with the channel surface. For example, a double layer of ions may include a first layer of ions attracted or adsorbed to the channel surface and a second layer of ions attracted to the ions in the first layer. Or, if the channel has been functionalized by immobilizing certain molecules or moieties (e.g., proteins, peptides, surfactants, polymers such as polyethylene glycol, or the like) to the channel surface, forming an ion-permeable layer with a net charge, then ions from the liquid may diffuse into the ion-permeable layer of immobilized molecules or moieties due to the Gibbs-Donnan effect, forming a Donnan equilibrium region, and creating a measurable Donnan capacitance. In either case, charges near the channel surface may act as a “screen” between the channel and the bulk of the sample fluid. Thus, steady-state, or low-frequency excitation and measurement may result in a measurement apparatus detecting effects on output signals for only the aspects or portions of a chemical or biochemical interaction that occur in or near the double layer, or the Donnan equilibrium region, and the electrostatic screening distance may be based on the thickness (e.g., Debye length) for a double layer and/or a Donnan equilibrium region.

The term “measurement bandwidth” as used herein refers to a band or range of frequencies for which output signals of a 2D field effect transistor are measured. For example, where discrete samples of the output signals are measured at a sampling rate, the measurement bandwidth may be a range from 0 Hz to half the sampling rate.

The term “bias” as used herein refers to an electrical signal or waveform applied to an electrode or terminal of a 2D field effect transistor, such as a source, drain, counter electrode, or another electrode. The term “programmable bias” is used to refer to a bias that is capable of being changed, varied, or modulated by the circuitry that applies the bias. Examples of programmable biases include a constant voltage or current selected by bias circuitry, a square wave, a sine wave, a more complicated waveform such as a sum of sine waves of various amplitudes, frequencies, and phases (possibly also including a zero-frequency or DC offset component), or the like.

The terms “target” or “target substance” as used herein, refers to a chemical or biological substance that is of interest in an assay using an integrated circuit, a 2D field effect transistor, or an array of 2D field effect transistor. “Target substance signal measurement” is used to refer to measuring one or more signals (e.g., output signals from a 2D field effect transistor array) that pertain to a target. Measurement and analysis of such signals may determine a parameter such as the presence, absence, or concentration of the target substance in a fluid. Examples of targets include ions, small molecules, compounds, proteins, bacteria, viruses, cells, and the like.

The term “synthetic biopolymer specific binding agent” as used herein refers to a molecule capable of forming a three-dimensional (2D) structure synthesized for specific binding to a selected target. Some synthetic biopolymer specific binding agents, such as aptamers, include single-stranded nucleic acid molecules. Further examples of synthetic biopolymer specific binding agents include other types of molecules such as peptides, saccharides, nucleic acid analogues, or the like. Different synthetic biopolymer specific binding agents may bind to different targets. For example, a variety of nucleic acid sequences may form different three-dimensional structures that bind to a variety of different targets.

### Introduction: Examples and Insights

Although graphene is still a relatively new entrant in the broader universe of technology with the Nobel prize for graphene being awarded in 2010, thousands of academic papers and patent applications have described various applications for graphene. The inventors of the present subject matter have written many papers and patent applications about processes for manufacturing and using graphene FETs in graphene biosignal processing units or BPUs™ for a wide range of applications in medical research, life sciences, agriculture, environmental monitoring and other uses. However, as manufacturing reliability process capacity continues expanding beyond 20,000 BPUs per month and interest in field monitoring applications grows, analyses that were routine for small experiments a lab or field needed new solutions.

The need for the apparatuses, methods, and models described herein for determining and using analytically efficient transfer curve parameters for scalable applications of sensor nodes that include sensor ICs with arrays of 2D FETs was largely inspired by the fact that existing methods of handling gFET transfer curves were causing the inventors of the present subject matter to artificially slow down and reduce the size of certain projects.

In one example application, designed and tested by the inventors, five sensor nodes with dispensing robot platforms were programmed to dispense samples to be tested to sixteen BPU chips on each robot platform and to monitor the biochemical interactions by capturing transfer curves data points for each BPU. The system was originally set up to take data 2000 times per second. Setting the excitation conditions and reading the output signals requires eight 16 bit data operations.

Without using the subject matter described herein, each sensor node needed to capture and upload 168 kB of transfer curve information per voltage sweep. Accordingly, for the sensor network of five sensor nodes with one robot dispenser and 16 BPUs per robot, the amount of transfer curve information that had to be handled was 13.54 MB per sec which equates to about 48 GB per hour or 1.125 terabytes per day.

Using the apparatuses and methods disclosed herein, the system was able to reduce the amount of transfer curve information needed from about 168 kB to about 12 bytes per voltage sweep which reduces the daily amount of transfer curve information needed to be communicated to about 82 MB per day. Furthermore, as will be explained in more detail below, as a result of developing the subject matter disclosed herein, the analytical efficiency of the output characterization parameters was increased meaning that beyond the raw data compression savings achieved there are also benefits related to the fundamental purpose of the biosignal processing assays which is to understand the nature and relationships of the biochemical interactions occurring on the BPUs.

Although these insights and examples of the inventors played a role in the development of the subject matter disclosed herein, it should be understood the material recounted here constitutes only a portion of the inventors’ experiences and objectives and should not be interpreted as limiting the scope of the claims. The remaining sections of the detailed description refer to the Figures to provide additional information about the systems, apparatuses, and methods for determining analytically efficient transfer curve parameters of sensor ICs with 2D field effect transistors.

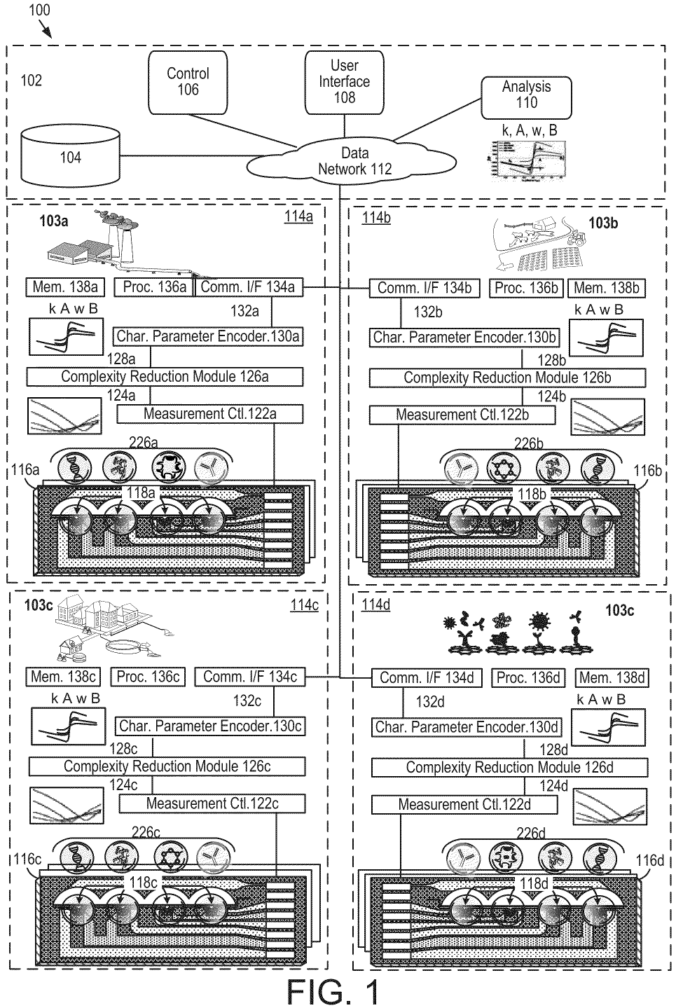

FIG. 1 is a schematic block diagram illustrating a system 100 for determining analytically efficient transfer curve parameters for integrated circuits with 2D field-effect transistor arrays for scalable applications using biosignal processing. As will be explained in further detail below, the inventors of the present subject matter have disclosed and developed various apparatuses and applications relating to 2D field-effect transistors for detecting and processing biochemical interactions. I-VG transfer curves for the 2D FETs 118, graphene channels 210 and similar materials. Although various researchers have been able to produce graphene I-VG transfer curves, manufacturing ultra-sensitive sensor ICs with gFETs that reliably and consistently produce I-VG transfer curves that can be used in portable and extensively scalable systems without problems based on chip-to-chip variations has been a yearned for but elusive dream. Accordingly, the apparatuses, systems, and methods disclosed herein provide solutions to address gaps in scalability found in existing systems.

The system 100 illustrates uses of scalable sensor ICs 116 that are manufacturable using commercially scalable methods of manufacturing such as the sensor ICs 116a, 116b, 116c, 116d, for detecting biochemical interactions or other types of biosignal processing that enables data from hundreds and thousands of 2D FETs 118 to be collected, stored, compared, processed, and acted upon in a wide variety of practical applications.

FIG. 1 also depicts representative categories of applications in which working examples of sensor ICs 116 comprising arrays of 2D FETs have been performed successfully. Such working examples include industrial applications 103a, agricultural application 103b, environmental and public health applications 103c, as well as health and life science research applications 103d, to name a few.

The system 100 includes a plurality of services nodes 102 that may be implemented as networked computing devices, cloud based nodes, and/or a combination of hardware and software nodes or modules. In various examples, the services nodes 102 include one or more storage nodes 104, control nodes 106, one or more user interface nodes 108, one or more analysis nodes 110, one or more control and/or one or more data networks 112.

In many examples, the system 100 is suitable for large scale applications in various environments with fixed infrastructure such as the application described in the above “Introduction: Examples and Insights” section in which the five sensor nodes 114 include the robot platforms with fluidic devices 208 that dispense samples to be tested to the sixteen sensor ICs 116 e.g., BPUs™,

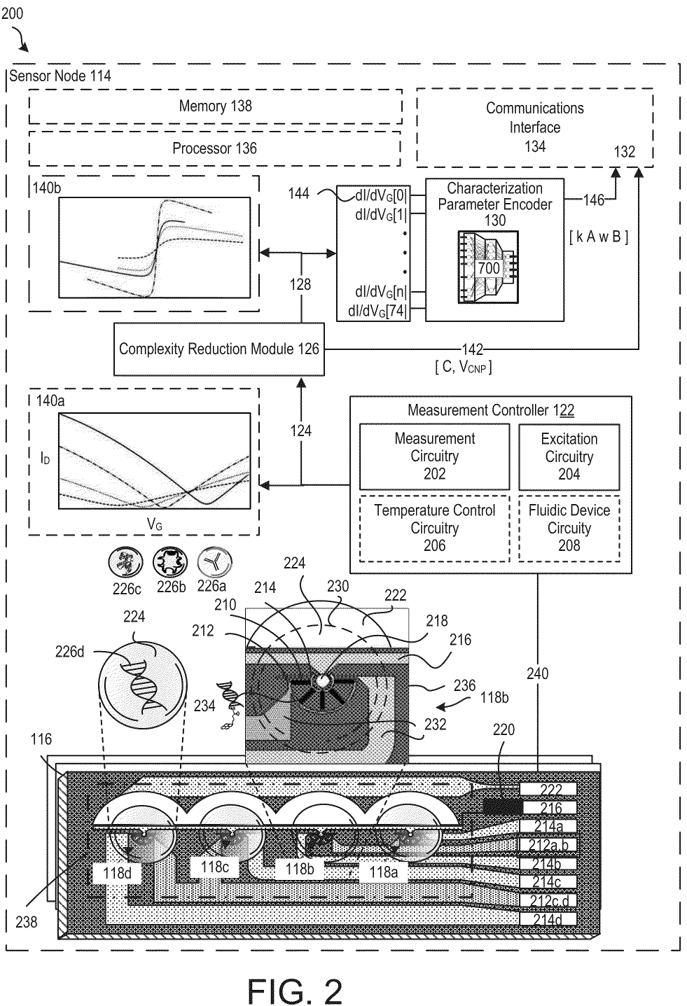

In various examples, the system 100 is suitable for large scale in-the-field or point-of-care applications due to the flexibility of the sensor nodes 114 such as the measurement controller 122, excitation circuity, and optionally fluid device circuitry 208 and/or temperature control circuitry 206 to be implemented in primarily using existing portable electronic devices. For example, in some implementations, a sensor node 114 implements the characterization parameter encoder 130 and complexity reduction module 126 using the processor 136, memory 138, display 140, and communication interface 134 of a smart phone, tablet, or other portable electronic device and the measurement controller 122 uses measurement circuitry 202 and excitation circuitry 204 (described in more detail with below with respect to FIG. 2) that are electronically coupled to the portable electronic device wirelessly via Bluetooth, Wi-Fi or any suitable wireless communication interface known to the skilled artisan or electronically coupled via a standard connector such as USB-A, micro USB, USB-C, microSD card, or the like.

The sensor IC 116, in various examples, includes chip scale packaging to be directly coupled without being assembled to a printed circuit board. In certain examples, the sensor IC is mounted to a printed circuit board.

Although four sensor nodes 114 are shown in the implementation of system 100 as depicted in FIG. 1, a system 100 may include an expandable number of sensor nodes 114 similar to other expandable networks.

The sensor nodes 114a-d may include varying numbers of sensor ICs 116 with different sized arrays of 2D FETs 118, such as gFETs, for detecting target substances 226a, 226b, 226c, 226d (a few of which are described below with respect to FIG. 2), interactions, or the like in a liquid. The depicted sensor IC 116 is referred to as a four-plex BPU™ and includes four simultaneously accessible 2D FETs that may be heterogeneously functionalized. For example, in one example implementation a first 2D FET 118a in a four-plex array on the sensor IC 116 is functionalized with for detecting Covid-19 spike proteins, a second 2D FET 118b is functionalized with a capture molecule for detecting human antibodies to Covid-19, the sensor nodes 114a-d may be used together at the same location or distributed across multiple locations, and may communicate with services nodes 102 (e.g., 104, 106, 108, 110) via a data network 112. The data network 112 may include a publicly accessible data networks such as the internet, a mobile telephony data network, or the like, and/or one or more private data networks such as a wireless local area network, or the like. Sensor nodes 114a-d are described in further detail below with reference to FIG. 2.

The storage nodes 104, the one or more analysis nodes 110, the one or more control nodes 106, and the one or more user interface nodes 108 may be separate devices, or may be integrated into a single central controller (indicated by a dashed line). The storage nodes 104 may include one or more data storage devices. The one or more analysis nodes 110, the one or more control nodes 106, and the one or more control nodes 106 may be computing devices, such as a processor executing code stored on a non-transitory computer-readable storage medium.

The storage nodes 104, in various examples, may be a virtual or physical device or set of devices capable of storing data. For example, the storage nodes 104 may be, or may include, a hard disk drive, a solid-state drive, a drive array, or the like. In the depicted example, the storage nodes 104 may be remote from the sensor nodes 114a-d. In certain examples, a storage nodes 104 may include network attached storage, a storage area network, or the like. In some examples, the storage nodes 104 may be a data storage device within a computing device. The storage nodes 104 may receive and store information from the sensor nodes 114, (e.g., 114a, 114b, 114c, 114d) such as output signals from the 2D FETs (e.g., gFETs), transfer curve information from 2D FETs, analysis results based on transfer curve, or the like.

The one or more analysis nodes 110 may perform analysis of data received from the sensor nodes 114a-d and/or stored by the data storage device. This analysis may be similar to the analysis described below performed at the local level on sensor nodes 114a-d, or may include different analysis techniques for making comparing results from different groups of sensor nodes in different locations or different environments. The one or more control nodes 106 may communicate with sensor nodes 114a-b to control the sensor nodes 114. The one or more control nodes 106 may present a user interface to a one or more users, allowing such users to access and/or control the one or more analysis nodes 110, the one or more control nodes 106, or the like.

As should be clear from the section titled introduction: insight and examples that for large scale applications with implemented in fixed infrastructure environments or in in-the-field or point-of-care applications or mixed environments, the inventors of the present subject matter disclosed herein recognized challenges with handling the amount of data generated using existing models and methods for 2D FET transfer curve generation and analysis. As will become throughout the present disclosure, by addressing these challenges as more than merely a processing performance problem or a data compression problem, the disclosed solutions presented herein present a significant advancement in 2D nanotechnology transfer curve modeling because apparatuses, systems, and methods disclosed herein improve gFET transfer curve system efficiency by four orders of magnitude and further improve analytical efficiency by making amplifying the visibility of parameters that relate to particular aspects of biochemical target characterization and detection of sensor IC defects.

FIG. 2 is a schematic block diagram illustrating an apparatus 200 that depicts a sensor node 114 such as any one or more of the sensor nodes 114a-d depicted in FIG. 1.

It may be helpful to begin this section referencing the depicted components of the apparatus 200 at a high level to illustrate and describe the role that each component plays in addressing the challenges described in the introduction section to provide a system with scalable apparatuses and models for determining analytically efficient transfer curve parameters of sensor ICs with 2D field effect transistors, certain components depicted in the illustrations are capable to provide significant improvements over existing systems.

For example, the apparatus 200 may be used in a system 100 that includes one or more storage nodes 104 and a plurality of distributed sensor nodes 114, where sensor node 114 includes one or more sensor ICs 116 with and array of 2D FETs 118 where the transistor channel 210 is formed in a layer of 2D nanomaterial (e.g., graphene) disposed on a substrate 236 (e.g., doped silicon or sapphire wafer). As shown in FIG. 2, the sensor ICs 116 include a gate area 230 for receiving a volume of liquid 224. The 2D FET has a conductive source 214 (e.g., Pt or Au) electrically coupled to a first end of the 2D transistor channel 210 and a conductive drain 212 electrically coupled to a second end of the 2D transistor channel 210. An insulating layer 232 (such as an oxide or nitride which is shown with hatching) is disposed over the conductive source 214 and the conductive drain 212 so that the liquid 224 is generally insulated from direct contact with the conductive source or conductive drain and directly contacts the 2D channel surface slightly inward from where it connects to the conductive source 214 and the conductive drain 212. The sensor ICs 116 include one or more integrated gate biasing electrodes 216, 222 disposed on the substrate for biasing and/or measuring electrical characteristics of the liquid 224 over gate areas 230 of the array 238.

Layer processing techniques do not require the use of a “wafer” but can be performed by one skilled in the art using substrates such as plastics and glass. Electronics packaging techniques may include without limitation, the addition of protective layers to a transistor channel, the separation of an array of devices via dicing or cutting into individual dies, connecting the dies to interconnects to aid in electronics assembly, encapsulation of portions of the combined dies and interconnects, testing of the manufactured module, and the removal of protective layers. Electronics assembly techniques may include without limitation testing of the manufactured module, and the removal of protective layers remaining from wafer processing and electronics packaging, integration of the packaged die with a printed circuit board or flexible printed circuit board, and integration of the packaged die with mechanical cases and fluidics systems. Electronics packaging and electronics assembly as disclosed with respect to the apparatuses, systems, and methods disclosed herein enables automated manufacturing and assembly processes, which in turn facilitates higher volume manufacturing with improved reliability. The disclosed systems using integrated circuits facilitate determining transfer curve parameters for a wide variety of target substances, leading to high availability of assays specific to individual target substances.

One or more layers of ions may form near the 2D transistor channel formed in a 2D nanomaterial, such as for example, a 2D transistor channel, of a 2D FET (e.g., gFET) when a liquid is applied in contact with the 2D channel. For ease of illustration and simplicity, this is often referred to and drawn as a “double layer” but is understood by one skilled in the art to be a complex arrangement of ions that is comprised of many layers and is specific to the chemical and electrical state of the sensor. If the 2D transistor channel surface has been functionalized by immobilizing certain molecules or moieties (e.g., proteins, peptides, surfactants, polymers such as polyethylene glycol, or the like) to the 2D channel, forming an ion-permeable layer with a net charge, then ions from the liquid may diffuse into the ion-permeable layer of immobilized molecules or moieties due to the Gibbs-Donnan effect, forming a Donnan equilibrium region. In either case, immobilization of molecules, moieties, and/or ions near the 2D transistor channel surface (e.g., in a double layer or a Donnan equilibrium region) may result in a change in capacitance and electric field between the channel of a 2D FET, such as a gFET, and the bulk of the applied fluid.

Various configurations of 2D FETs, such as gFETs, 118 and ways to fabricate 2D FETs, such as gFETs, 118 are discussed in U.S. Pat. 10,903,319 titled “Patterning Graphene With A Hard Mask Coating”; U.S. Pat. 11,056,343 titled “Providing A Temporary Protective Layer On A Graphene Sheet”; U.S. Pat. 10,751,986 titled “Systems For Transferring Graphene”; U.S. Pat. 9,859,394 titled “Graphene FET Devices, Systems, And Methods Of Using The Same For Sequencing”; and U.S. Pat. 10,395,928 titled “Depositing A Passivation Layer On A Graphene Sheet”; each of which is incorporated herein by reference in their entireties to the extent legally allowable; PCT/EP2023/052276 titled “Graphene Sensors And A Method Of Manufacture”; US Application 18/101,212 titled “A Biosensor Device And A Method Of Manufacturing A Biosensor Device.”

Multiple electrical connections 240 to and from the sensor IC 116 typically include the connections to the integrated gate biasing electrodes 216, 222 where a large disc-shaped counter electrode 222 is used to provide an evenly distributed gate bias voltage to as much liquid 224 as possible within the gate area 230 and a reference electrode 216 which connects to a small exposed center point terminal at the center of the gate area 230 and the spoke like segments of the 2D transistor channel 210 so as to measure an accurate representation of the voltage at the 2D transistor channel 210. The electrical connections 240 also typically include connections to the conductive drains 212 and the conductive sources 214 of the 2D FETs 118 in the array 238.

One or more surface chemistries 234 may be applied to individual 2D FETs 118 or to groups of 2D FETs 118. Sensor ICs 116 are sometimes referred to as a biosensor ICs or BPU chips because of the sensor ICs is to analyze transfer curve information of interest such as the response of 2D FET output current to repeating input gate bias voltage sweeps using 2D FET that a functionalized with surface chemistries 234 formulated to bind and hold target substances 226 of interest close to the channels 210. Thousands and thousands of target substances such as DNA 226d, RNA 226c, antibodies 226a, substances coated with binding agents 226b such a biotin, streptavidin, or similar biological binding agents can be characterized based on the transfer curve information generated by the sensor node 114 but as indicated in the introduction section to do so at scale requires not only a high-quality sensitive sensor IC 116 that can be manufactured consistently to meet demanding specifications but also requires apparatuses and models which allow analytically efficient output characterization parameters 132 to be efficiently reconstructed or directly determined from the transfer curve information generated by the large numbers of sensor ICs 116.

Although many models and apparatuses described herein may be used in applications that differ somewhat from those depicted in the drawings, in various examples, a sensor node 114 may include a communication interface 134, a measurement controller 122, a characterization parameter encoder 130, and one or more sensor integrated circuits (“ICs”) 116a-d, which are described below. Although FIG. 2 depicts a sensor node 114 including four sensor ICs 116a-d, another example of a sensor node 114 may include more or fewer sensor ICs 116.

A sensor IC 116, in the depicted example, includes one or more 2D FETs (e.g., gFETs), which are described in further detail below. In some examples, a sensor IC 116 may include a sensor array of multiple 2D FETs (e.g., gFETs). The sensor ICs 116 disclosed herein may be built using traditional electronics manufacturing techniques such as, for example, layered processing (e.g., as is sometimes done using silicon wafers), electronics packaging, and electronics assembly techniques. Layered processing techniques (such as for example, wafer processing) may include without limitation layer deposition, removal, patterning, and modification of layer electrical properties. The disclosed structures and methods enable more reliable performance, integration of electrical modules, and lower costs.

In some examples, a sensor IC 116 may include a plurality of transistors where at least one of the transistors is a 2D FET (e.g., gFET). In some examples, a sensor IC 116 may include one or more additional sensors that do not use field-effect sensing, alongside 2D FETs (e.g., gFETs). For example, various types of sensors may be included that use terahertz spectroscopy, surface-enhanced spectroscopy, quartz crystal microbalance, grating-coupled interferometry, and so forth. In some examples, a sensor IC 116 may include or be coupled to further components such as a flow cell or liquid propulsion mechanism. As depicted, the sensor node 114 may include one or more sensor ICs 116. In the depicted example, the sensor IC 116 is a multiplexed sensor IC with four 2D FETs 118, such as gFETs. In the enlarged inset of 2D FET 118b, it can be seen that the 2D FETs 118 (e.g., 118a - 118d) are disposed on a substrate. Each transistor includes a channel 210 (which as depicted may include multiple graphene segments) that links a drain 212 to a source 214. In the depicted example, four terminals for the drains 212 are provided, one per transistor, and two terminals for the source 214 are provided so that each source 214 is shared by two 2D FETs 118. One or more reference electrodes 216 with center point terminals 218, are coupled to an integrated resistor 220, and run in series along the side of the transistors, close to the channels 210, and semicircular counter electrodes 222 run in series along the side of the 2D FETs 118, further away from the 2D FETs 118 than the reference electrodes 216.

In various implementations, each sensor IC 116 includes an array of 2D FETs 118 each with a 2D transistor channel 210 formed in a layer of 2D nanomaterial such as graphene disposed on a substrate, such as for example, silicon or aluminum oxide, a gate area 230 for receiving a volume of liquid 224, a conductive source 214 electrically coupled to a first end of the 2D transistor channel 210, a conductive drain 212 electrically coupled to a second end of the 2D transistor channel 210 an insulating layer 232 disposed over the conductive source 214 and the conductive drain 212. The insulating layer 232 is illustrated as a dark dot pattern over the entire transistor area depicted in the enlarged inset (except at the center point terminal 218 of the reference electrode 216 and semicircular counter electrode 222 which are not depicted with a pattern because they are exposed to the liquid 224.)

Each 2D FET 118 includes one or more integrated gate biasing electrodes disposed on the substrate for biasing and/or measuring electrical characteristics of the liquid 224 over the gate areas 230 of the array [118a-118d] of 2D FETs 118.

The measurement controller 122 determines transfer curve information 124 for the 2D FETs 118 of the array by applying bias conditions including a drain-to-source voltage and a gate-to-source voltage, and measuring channel currents for the 2D FETs 118 while varying the gate-to-source voltage.

In the example depicted in FIG. 2, the counter electrodes 222 are connected together and the reference electrodes 216 are connected together. In certain implementations, such as, for example, where liquid samples are analyzed independently on the same chip, one or more counter electrodes may be driven by different sources and one or more reference electrodes may be used to separately measure liquid gate voltages. Furthermore, different electrode geometries may be selected for various implementations of counter electrodes and reference electrodes according to one or more examples of the present disclosure.

The sensor IC 116s shown in FIGS. 1 and 2 represent examples of integrated circuit apparatuses and systems described herein, which have been manufactured in the US and may also be manufactured in the UK and other locations by Paragraf Ltd, of Somersham, UK, using microelectronic and microelectromechanical systems (MEMS) manufacturing processes.

The sensor node 114 includes a measurement controller 122 that is operable to determine transfer curve information for the 2D FETs 118 of the array by applying bias conditions including a drain-to-source voltage V_{DS} and a gate-to-source voltage V_{GS}, and measuring drain currents I_{DS} for the 2D FETs 118 while varying the gate-to-source voltage V_{GS}.

In one beneficial example, the sensor node 114 includes a characterization parameter encoder 130 that is operable to determine a set of output characterization parameters 132 for a form of an equation that models a reduced complexity form of a transfer curve, by applying a machine learning model 700 to a reduced complexity form of transfer curve information 128 from the measurement controller 122, where the machine learning model 700 is trained to associate the reduced complexity form of transfer curve information 128 with the set of output characterization parameters 132.

In the example implementation described in the Introduction section, the reduced complexity form of the transfer curve information 128 was a first derivative form of the I-Vg transfer curves for graphene FETs depicted on the display 140b in FIG. 2.

The first derivative curve information 128 (e.g., 60 to 75 points on each transfer curve) were produced by the complexity reduction module 126 which first reduced the complexity parameterization decoding function to be performed by the machine learning model 700 by separating certain parameters as non-encoded output characterization parameters 142 (output characterization parameters that are part of the transfer curve in standard form but which do not need to be encoded in the machine learning model because they can be directly measured or calculated more analytically efficiently using only one or two points of the transfer curve without curve fitting.

As recounted in the introduction section, using this example implementation, the number of byte per transfer curve was reduced from 168 kilobytes to only 12 bytes, which for the example system with five sensor nodes reduced the daily transfer curve data load from 1.125 terabytes per day to about 82 megabytes per day.

The measurement controller 122 depicted in the sensor node 114 includes excitation circuitry 204 and measurement circuitry 204. Certain components indicated by dashed lines in FIG. 2 are included in the depicted example, but may be omitted in certain examples. In the depicted example, the measurement controller 122 includes temperature control circuitry 206, one or more fluidic devices 208, and communications interface 134.

In various examples, the measurement controller 122 may use excitation circuitry 204 to apply excitation conditions to 2D FETs (e.g., gFETs), and may use measurement circuitry 202 to perform one or more measurements of at least one of the one or more output signals from the 2D FETs. The output signal(s) may be affected by the excitation conditions, and by events or occurrences (such as the presence of a target substance) near the channel surface. In various examples, the measurement controller 122 may communicate transfer curve information to a characterization parameter encoder 130 that determines transfer curve parameters, based on the one or more measurements from the measurement circuitry 202.

In the depicted example, the measurement controller 122 includes circuitry for communicating with (e.g., sending electrical and/or electromagnetic signals to or receiving electrical and/or electromagnetic signals from) components of one or more sensor ICs 116. A measurement controller 122, in various examples, may include excitation circuitry to apply excitation conditions to a sensor IC 116, including a 2D FET, such as a gFET, or a capacitive sensor. The sensor IC 116 may produce various output signals based on the excitation conditions. For example, where the excitation conditions include a drain-to-source voltage and a liquid gate voltage for a 2D FET, output signals may include a drain-to-source current, Dirac point voltage, or other types of signals that are discussed in further detail herein. A measurement controller 122, in various examples, may include measurement circuitry to determine or measure output signals from the sensor IC 116.

The excitation circuitry 204, in the depicted example, is operable to apply one or more excitation conditions to a 2D FET 118, such as a gFET, or a set of 2D FETs 118 (e.g., gFETs). An excitation condition, in various examples, may be a physical, chemical, or electrical condition applied to a 2D FETS, such as a voltage, amplitude, frequency, amplitude, phase, a light, or waveform for an electrical or electrochemical excitation, a temperature, a liquid flow rate, or the like. The excitation circuitry 204 may be any circuitry that applies, modifies, removes, or otherwise controls one or more excitation conditions.

In some examples, excitation such as light, heat, electromagnetic energy or other forms of excitation may be precisely and/or individually programmed to be applied to one or more specific 2D FETs 118 (e.g., gFETs) to mediate, stimulate, diminish, propel, repel, mix, modulate, or otherwise control biochemical components and interactions in proximity to the excitation source and the corresponding transistor(s).

In various examples, excitation conditions may include one or more electrical signals applied to a 2D FET 118 (e.g., gFET) (or electrochemical potentials applied to the fluid), such as constant-voltage biases or time-varying excitation signals. Excitation circuitry 204 may produce biases or other excitation signals or couple them to the 2D FET (e.g., via a source 214, drain 212, or counter electrode 222). Accordingly, in various examples, excitation circuitry 204 may include any circuitry capable of generating or modulating biases or excitation signals, such as power supplies, voltage sources, current sources, oscillators, amplifiers, function generators, bias tees (e.g., to add a DC offset to an oscillating waveform), a processor executing code to control input/output pins, signal generation portions of source measure units, lock-in amplifiers, network analyzers, chemical impedance analyzers, or the like. Excitation circuitry 204 in various other or further examples may include various other or further circuitry for creating and applying programmable biases. In some examples, excitation conditions may include a temperature for the liquid applied to a 2D FET (e.g., gFET), and excitation circuitry 204 may use temperature control circuitry 206 to control the temperature.

The temperature control circuitry 206, in various examples, controls the temperature including increasing or decreasing the temperature (e.g., to detect or analyze temperature-sensitive aspects of a biochemical interaction) maintaining a temperature in a range or near a target temperature, monitoring temperature for feedback-based control, or the like. Thus, as described above, temperature control circuitry 206 may include any circuitry capable of changing the temperature of the liquid and/or the 2D FET . For example, in various examples, temperature control circuitry 206 may include a resistive heater, a Joule heating controller to control current in a resistive heater (or in the channel 210 itself), a solid-state heat pump, a thermistor, or the like. Temperature control circuitry 206 in various other or further examples may include various other or further circuitry for controlling or measuring a temperature.

Certain types of excitation circuitry 204 can be produced side-by-side with 2D FETs 118, such as gFETs, using the same manufacturing tools and very similar processes. Combining 2D FETs 118 with these other types of circuitry is enabled, at least in part, using processes, methods, designs, and manufacturing steps described above or included in incorporated references. Various other or further types of excitation circuitry 204 may be used to apply various other or further excitation conditions.

Additionally, in certain examples, excitation circuitry 204 may include other or further circuitry, for applying excitation conditions other than or in addition to electrical signals and/or temperature. For example, excitation circuitry 204 may include electromagnets for magnetic excitation, light emitters of any desired wavelength, radioactive sources, emitters of ultraviolet light, x-rays, gamma rays, electron beams, or the like, ultrasonic transducers, mechanical agitators, or the like.

Fluidic device circuitry 208 is included in various examples in the measurement controller 122, such as for example circuitry that interfaces with automated open protocol robotic platforms, micro dispenser, mixers, rinsers, valves, filters, heaters, coolers, sensors, and other devices that that perform functions for fluids used in conjunction with the sensor ICs 116.

As described above, one or more output signals e.g., sources 214a, 214b, 214c, 214b for the corresponding 2D FET 118 (e.g., gFET) may be affected by substances near the respective two-dimensional nanomaterial channel, such as for example, a 2D transistor channel. Thus, changes to the transfer curve parameters may indicate the presence of a target substance. With multiple 2D FETs functionalized in different ways, surface chemistries 234 for capturing target substances may affect transfer curves for 2D FETs functionalized to interact with those targets. Additionally, substances that are not the target of a particular assay or functionalized 2D FET may be characterized based on their effects on transfer curves across the array of 2D FETs.

In various examples, the measurement circuitry 202 may be operable to perform one or more measurements of 2D FET output signals such as drain-to-source currents. For example, the measurement circuitry 202 may measure initial and final output signals, output signals for the liquid and for a control fluid, or the like. Additionally, in some examples, the measurement circuitry 202 may be operable to perform a plurality of time-dependent measurements of one or more output signals.

Measurement circuitry 202, in various examples, may include any circuitry capable of performing measurements of one or more output signals. For example, in some examples, measurement circuitry 202 may include preamplifiers, amplifiers, filters, voltage followers, data acquisition (DAQ) devices or boards, sensor or transducer circuitry, signal conditioning circuitry, an analog-to-digital converter, a processor executing code to receive and process signals via input/output pins, measurement portions of source measure units, lock-in amplifiers, network analyzers, chemical impedance analyzers, or the like. Measurement circuitry 202 in various other or further examples may include various other or further circuitry for performing measurements of output signals.

In the depicted example, the measurement circuitry 202 includes circuitry for performing electrical measurements. Electrical measurements may be measurements of electrical and/or electrochemical output signals. For example, in various examples, electrical output signals may be measured via the source 214 and drain 212 terminals of a 2D FET 118(e.g., gFET). In certain examples, the measurements include measurements of an electrochemical potential of the liquid 224 via a reference electrode 216 of the 2D FET.

In various examples, portions or components of excitation circuitry 204 and/or measurement circuitry 202 may be disposed in a sensor IC 116, a sensor node 114, or in a separate device (e.g., lab bench test and measurement equipment) coupled to the sensor IC 116. For example, single-use components such as a resistive heater component for excitation circuitry 204 may be disposed on a sensor IC 116, while multi-use components such a digital signal processing circuitry for generating or analyzing complex waveforms may be disposed in a chip reader that can be connected to or disconnected from multiple sensor ICs. Various other ways to dispose or arrange portions or components of excitation circuitry 204 and/or measurement circuitry 202 may be used in various other examples. The measurement controller 122 applies excitation conditions to sensor ICs 116.

For example, to produce transfer curve information 124, which may refer as depicted to one or more standard I-V_{G} curves, the measurement controller applies a sweeping series of incrementally varying liquid gate voltages to the 2D FETs 118 through the counter electrode 222 and measures liquid gate voltage V_{G} using the reference electrode 216 which is exposed to the liquid 224 at the center point terminal 218 so as to more accurately represent the voltage found at the surface of the 2D channel 210 (e.g., graphene).

Transfer curve information 124 such as depicted in display 140a may be determined by the measurement controller 122 for one or more 2D FETs 118, such as gFETs, of a sensor IC 116.

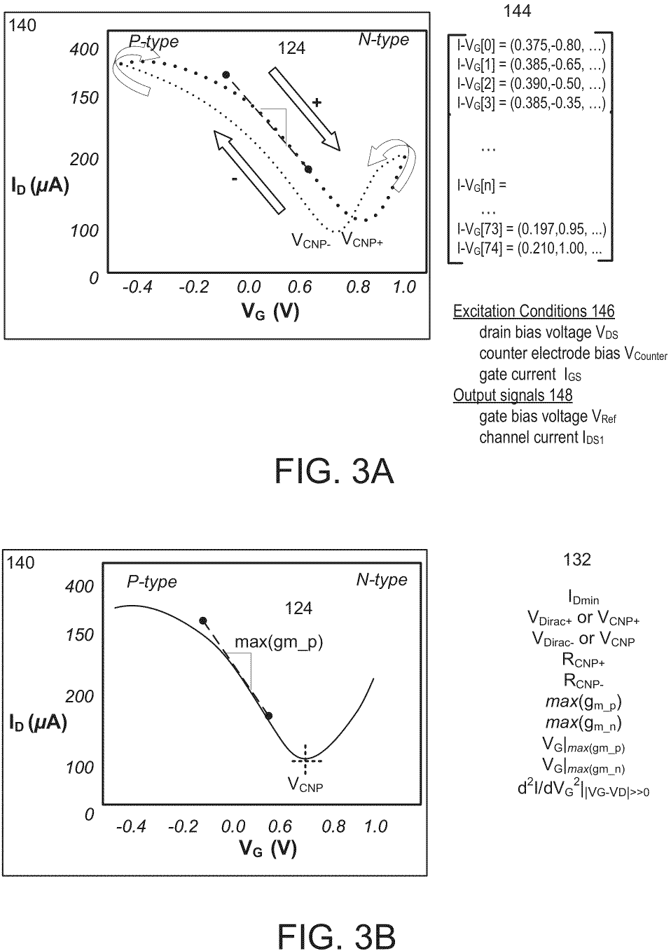

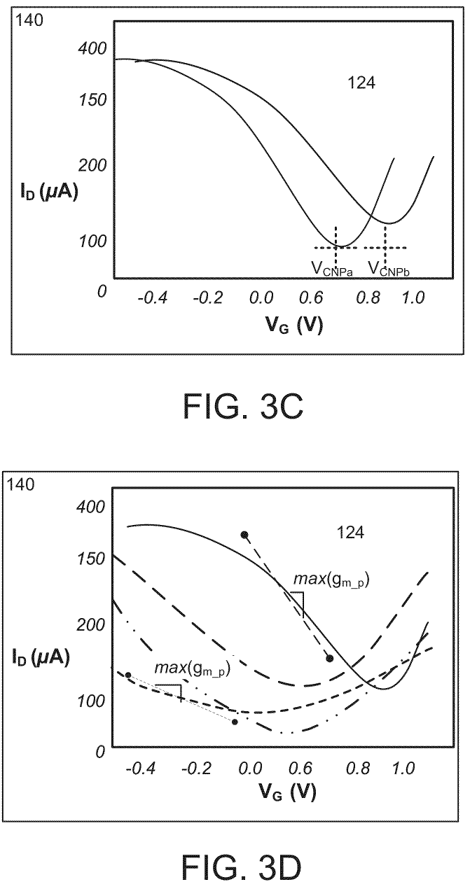

FIG. 3A is an illustration of typical transfer curve information 124 in the form of a transfer curve often referred to as an I-V_{G} curve for a liquid gated 2D FET with a graphene channel (e.g., a gFET) that maps gate conditions to the transistor current shows as V_{G} or V_{GS}, and may be represented as a graph with an input condition such as the gate voltage on one axis and an output condition such as a drain current on the other axis. Transfer curve information, in various examples, may be information about the transfer curve, such as experimentally determined points on a transfer curve.

Thus, in some examples, a measurement controller 122 may determine transfer curve information for one or more 2D FETs (e.g., gFETs) by applying bias conditions including a drain-to-source voltage and a gate-to-source voltage, and measuring drain currents for the 2D FETs while varying the gate-to-source voltage. The transfer curve information may include a set of points where each point includes the applied gate-to-source voltage and the measured drain-to-source current. The measurement controller 122 may sweep the gate voltage one or more times, and determine transfer curve information by measuring drain-to-source currents during the one or more sweeps. Unless otherwise clear from context, as used herein, references to transfer curve information should be understood as including references to transfer curves in their standard form or in a modified form such as a reduced complexity form, or to portions of transfer curves, or characteristics of the transfer curves, and so forth.

A complexity reduction module 126 is included, in one or more examples, in the apparatus 200, that produces one or more reduced complexity forms of the transfer curve information 124 by applying one or more operations to the transfer curve information 124 in the set in response to determining that applying the one or more operations continues to satisfy a predetermined goodness of fit requirement.

FIG. 3A is an illustration of transfer curve information 124 for a liquid gated 2D FET 118 with a graphene channel 210 or gFET. In some examples, the transfer curve information 124 includes one or more vectors 144 with elements or points corresponding to 2D FET excitation conditions 150 at least a portion of which are varied in accordance with a predetermined incrementally varying voltage sweep of a liquid gate bias voltage and/or a 2D channel input bias voltage varied at a predetermined characteristic resonance frequencies and further comprising output elements corresponding to 2D FET output signals at least a portion of which are generated in response to the 2D FET excitation conditions 150 and to biochemical interactions occurring in the fluid.

It may be noted that although the transfer curve information 124 may be displayed as continuously smooth curves I-V_{G} transfer curves, the transfer curve information 124 may be a vector that includes instructions and/or values for programming, writing, setting, and/or confirming excitation conditions 150 and/or values or instructions for reading values of output signals 152 from the 2D FETs. Moreover, as depicted in FIG. 3A, a complete transfer curve may include an incrementally increasing voltage sweep or forward voltage sweep depicted with plus symbol next to a downward sloping arrow followed by incrementally decreasing negative voltage sweep depicted with a minus symbol next to an upward sloping arrow.

In various example implementations, including the examples encoded in the machine learning model 700, the drain bias voltage V_{DS} is a constant DC voltage. In certain example implementations, the excitation circuitry 204 is configured to vary one or more of the programmable drain or source biases at the one or more characteristic resonance frequencies of the biochemical interaction in order to analyze a spectroscopic response of the transfer curve to the biochemical interactions according to the methods set forth by the inventors of the present subject matter in US application 17/342,284 titled “Dynamic excitation and measurement of biochemical interactions” filed Jun. 8, 2021 which is incorporated by reference to the extent legally allowable.

FIG. 3B is an illustration of output characterization parameters 132 which the inventors of the present subject matter also referred to as measurement vector elements. As used herein, the term “output characterization parameters” refers to parameters that relate to a form of a transfer curve equation or model the models or predicts the response of a device such as a liquid gated 2D FET for a range of respected 2D FETs.

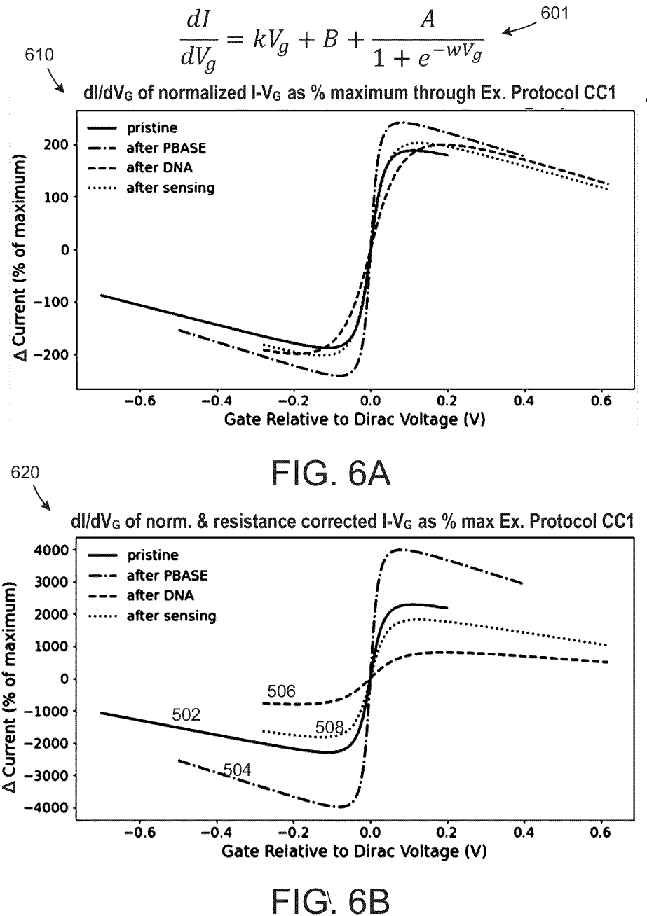

Some output characterization parameters 132 may relate to a standard form of a transfer curve equation or model the models or predicts the response of a device such as a liquid gated 2D FET for a range of respected 2D FETs. As will be discussed in more detail below with respect to FIGS. 6A-6E, other output characterization parameters 132 may relate to reduce complexity form of a transfer curve information such as various normalized versions of standard I-VG transfer curve information and/or a first derivative of an equation that models a transfer curve.

Various apparatuses models disclosed herein are configured to determine analytically efficient transfer curve parameters that effectively model or predict the response of the device taking into account the range of 2D FET design and process parameters but also using those parameter to detect and analyze the response of the 2D FETs to specific biological samples applied to the 2D FET based on the transfer curve models taking into account the effects of interactions between biochemical activities in the liquid and the 2D FET.

FIG. 3C is an illustration of a transfer curve differences in charge neutrality point for a liquid gated 2D FET with a graphene channel, according to one or more examples of the present disclosure. Certain parameters such as the Dirac voltage (also referred to as V_{CNP}) on a liquid gated gFET are among the most visible and earliest recognized output characterization parameters for liquid gated gFETs. Such shifts indicate a change in pH in the sample fluid and gFET based pH sensors have been made that utilize this parameter which is also useful for other characterization purposes.

FIG. 3D is an illustration of a transfer curve differences in overall shape and slope for a liquid gated 2D FET with a graphene channel, according to one or more examples of the present disclosure. The inventors of the present subject matter of have previous developed and disclosed systems, apparatuses, and methods which use differences in slopes of gFET transfer curves to determine differences in biomolecules being tested by different gFETs in an array of gFETs as disclosed in U.S. Pats. 11,092,598, US 11,215,580, US 11,536,722.

As described in the introduction section, as manufacturing reliability process capacity be expanded to tens of thousands of sensor ICs 116 per month and interest in larger networks of sensor nodes 114 and larger networks of in-the-field or point-of-care biosensing applications 103 continue to grow, the inventors of the present subject matter recognized a need for scalable apparatuses and models for determining analytically efficient transfer curve parameters of sensor ICs with 2D field-effect transistors.

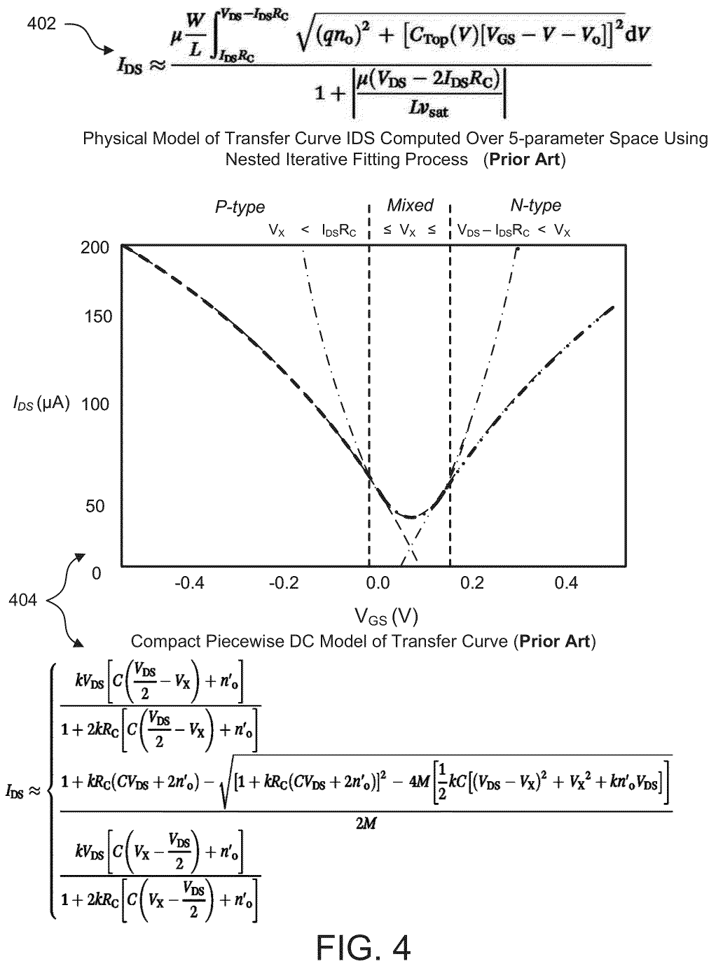

FIG. 4 is an illustration of a compact piecewise model for extracting device parameters for electrolytically gated graphene FETs. According to a journal article by “Mackin, C. and Palacios, T., 2016 titled “Large-scale sensor systems based on graphene electrolyte-gated field-effect transistor” ANALYST, 141(9), pp.2704-2711, a physical model depicted with the reference number 402 “has been shown capable of fitting experimental data with great accuracy, but is computationally expensive. The title of the article seemed to offer hope that the compact model developed by the author might offer a solution or at least a suggestion that would address the problem encountered by the inventors of the present subject matter.

Although a compact piecewise model 404 was developed by the article research team and was purportedly able to characterize IDS as a function of VDS and VGS for 256 EGFETs with a matter of minutes, for each transfer curve the problem had to be divided into three regions selected based on whether Vx is less than I_{DS}R_{C}, Vx is greater than I_{DS}R_{C} but less than V_{DS} - I_{DS}R_{C} or Vx is greater than V_{DS} - I_{DS}R_{C} where each region has a different curve fitting equation which would appear to increase the complexity of data communications involving 1 to 4 gFETs per chip rather than an EGFET array of 256 which appear to be integrated all on a single chip as appeared to be the case in the article.

Also, a mean percent error of 7% or less for 87% of the devices on the same chip as purported by the article might have been useful for understanding certain process parameter correlation coefficients to develop some intuition regarding performance or for scalable apparatuses and models for determining analytically efficient transfer curve parameters of sensor ICs with 2D field effect transistors are disclosed. However, nothing in the model appear to provide guidance for how to use the compact gFET transfer curve model or form of model for 2D FET transfer curve information in scalable apparatuses and models for determining analytically efficient transfer curve parameters of sensor ICs with 2D field effect transistors.

Lastly and significantly, none of the curve-fitting described in the article appear to involve testing of transfer curves in the presence of gFETs functionalized with a representative range of surface chemistries and tested with a corresponding range of biological samples. Accordingly, one would naturally expect the extracted parameters to be either process dependent parameters or design dependent parameters where any effect of biological interactions on the parameters presented in the model is left as an exercise for further research. Accordingly, the inventors of the present subject matter determined to take an entirely different approach.

The detailed description of FIG. 2 may now continue with the additional insights about various approaches and challenges associated with generating and communicating transfer curve information 124 in ways that provide analytically efficient output characterization parameters as described with respect to FIGS. 3A, 3D, 3C, 3D, and FIG. 4.

A complexity reduction module 126, as mentioned above, is included in the apparatus 200 in one or more examples. The complexity reduction module 126 produces one or more reduced complexity forms of the transfer curve information 124 by applying one or more operations to the transfer curve information 124 in the set in response to determining that applying the one or more operations continues to satisfy a predetermined goodness of fit requirement.

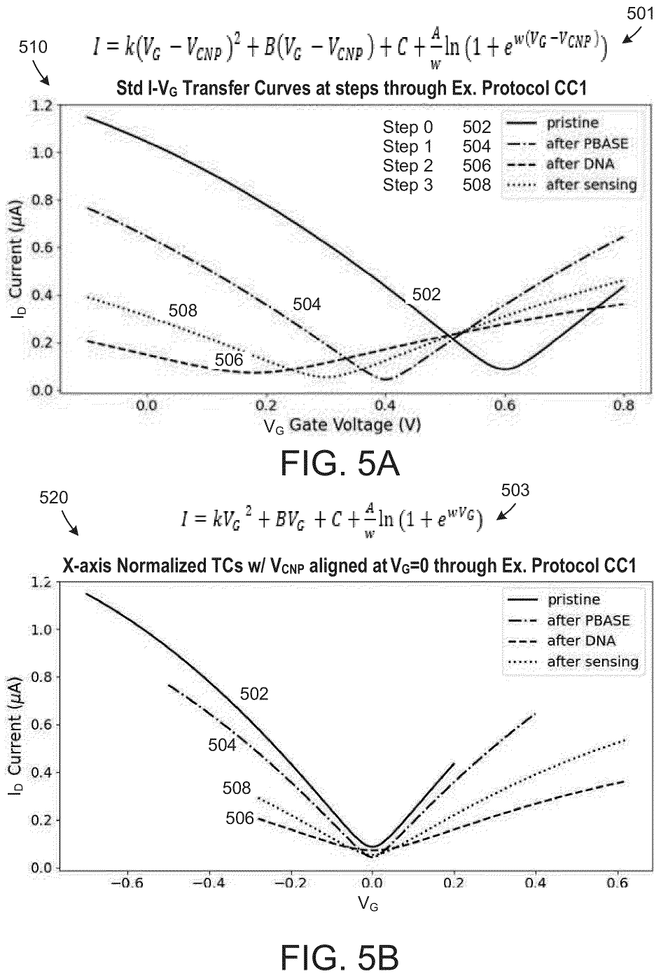

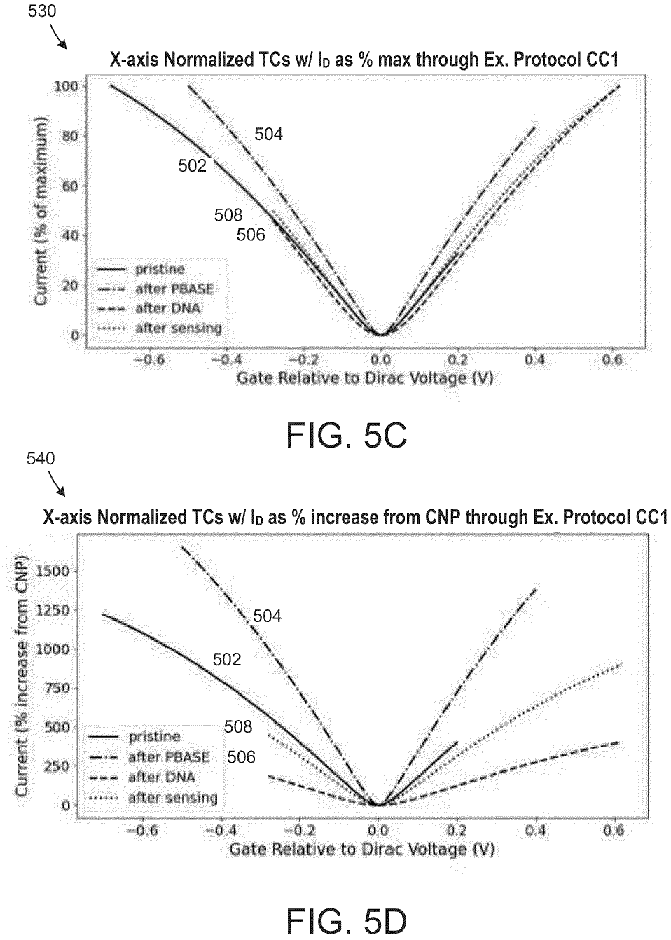

FIG. 5A is an illustration of a chart 510 of results showing four transfer curves or TCs (output current to liquid gate voltage) for a 2D FET in a predeposition pristine 2D nanomaterials (e.g., graphene) state and after deposition of selected thin film surface chemistry and biological sample layers, in accordance with an example protocol referred to as Protocol CC1. Although the Protocol CC1, uses linkers and CRISPR-Cas9 complexes for detecting target chains in whole genomic DNA, similar transfer curves would be observed in other protocols, and the methods and apparatuses described herein are validated and tested with a broad range of surface chemistries and target biomolecules including proteins, antibodies, aptamers, RNA, DNA, and the like.

One example form of an I-V_{G} curve for a 2D FET with a graphene channel is shown in equation 501.

$$I = k {\left({V}_{G} - {V}_{C N P}\right)}^{2} + B \left({V}_{G} - {V}_{C N P}\right) + C + \frac{A}{W} ln \left(1 + {e}^{w \left({V}_{G} - {V}_{C N P}\right)}\right) \qquad \text{(501)}$$

Example Protocol CC1 refers to an Example Protocol for using a CRISPR-Chip® version of a sensor IC with a CRISPR-Cas9 complex immobilized by a PBASE linker to graphene channels of a 2D-FET to detect unamplified target genes.

I is the channel current often referred to as I_{D} drain current or I_{DS} drain to source current. In graphene FETs, source and drain may sometimes be interchanged.

C is a minimum current or current at the charge neutrality point.

B is a current offset of the curve related to skew.

A is a maximum current.

V_{CNP} is the voltage at the charge neutrality point.

By instructing the complexity reduction module 126 to normalize the I-V_{G} curves at V_{G} = 0 by subtracting the value of V_{CNP} from each of the transfer curve voltage values V_{G} the fit function for the machine learning model to encode now becomes a five parameter function.

Looking only at the individual transfer curves depicted in FIG. 5A in isolation without taking into account the apparatuses, systems, and methods disclosed, a person of ordinary skill may focus primarily on a leftward (negative voltage) shift in the respective Dirac voltage or charge neutrality point of each TC.

Therefore, the I-V_{G} transfer curve of step 0 records a vector of TC information for the pristine graphene layer transfer curve 502 in a buffer (where may also be considered to be a layer 0 because it serves as a baseline substrate upon which thin film surface chemistry layers are deposited.

The I-V_{G} transfer curve after PBASE, curve 504, is a vector of TC information for a linker layer of PBASE which is 1-pyrenebutanoic acid succinimidyl ester, a linker molecule that can link capture molecules such as CRISPR-Cas9 complexes with graphene. After deposition of PBASE, the most easily noticed change from a transfer curve 502 is the shift in the Dirac voltage (the voltage at which the current is minimized, also the charge neutrality point). This large change indicates a significant shift in the surface potential of the transistor. However, a change in surface potential is neither necessary nor sufficient to indicate deposition of a material. There are several other parameters that have changed in this curve that are not easily visible by eye. For example, the resistance of the graphene channel has changed. This is difficult to see by eye, but still visible as a small downward overall shift in the curve. There are several other changes to the curve that can only be quantified using more complex computational methods which involve being reduced in complexity by the complexity reduction module 126 and encoded by the characterization parameter encoder 130 as described below in order to reduce computational intensity and improve analytical parameter efficiency.

The I- V_{G} transfer curve after deposition of DNA on the surface of this sensor is shown as the DNA transfer curve 506 (which is the second thin film deposited but surprisingly appears to be the third curve below the baseline transfer curve 502 for the pristine graphene rather than the second curve). The after DNA transfer curve 506 shows a significant shift in Dirac voltage, as well as a large change in transconductance (the derivative of the I-V_{G} curve which is visible as a decrease in slope) and a decrease in the curvature (the second derivative of the I-V_{G} curve) near the Dirac voltage. In addition, there is a slight, but noticeable, decrease in resistance.

The I-V_{G} transfer curve after sensing is shown in curve 508. This curve shows removal of DNA material after a sensing event. In addition to the change in Dirac voltage, there is an increase in slope, a decrease in resistance, and an increase in curvature. Parameters such as this bring additional information about the character and amount of material deposited on (or in this instance removed from) the surface.

Accordingly, referring also to FIGS. 2 and 3A, in various example implementations, the complexity reduction module 126 separates output characterization parameters 132 into non-encoded output characterization parameters which includes parameters from equation 1 such as the minimum current point C in or V_{CNP} charge neutrality point voltage because both of these parameters relate to the charge neutrality point which is clearly affected by biochemical interactions and is relatively easily calculated without curve fitting.

For each transfer curve vector 144 depicted in FIG. 3A, one non-encoded output characterization parameters 142 is ‘C’ because the lowest channel current point of all the channel currents in the transfer curve vector can be measured and determined directly without curve fitting.

The charge neutrality point voltage V_{CNP} is also treated as a non-encoded output characterization parameter 142 but determining it can be more simply calculated from the transfer curve in first derivative form as will be explained in more detail below.

FIG. 5B is an illustration of a chart 520 with results from a reduced complexity form of the I-V_{G} curves for FIG. 5A where the transfer curves are normalized to align the Dirac voltage of each curve (voltage at charge neutrality point) at V_{G}=0 along an x-axis.

$$I = K {V}_{G} + B {V}_{G} + C + \frac{A}{W} ln \left(1 + {e}^{w {V}_{G}}\right) \qquad \text{(503)}$$

The transfer curve model shown in equation 2 has five output characterization parameters because the V_{CNP} is determined separately as described below by the complexity reduction module 126. As explained above, the output characterization parameters C is simply a constant and thus can be treated as a non-encoded output characterization parameter 142.

The complexity reduction module 126 produces normalized transfer curve information 128 along an x-axis representing gate voltage by subtracting a charge neutrality point voltage from a gate voltage for the transfer curves to align lowest points of the transfer curves at a V_{G}=0 point along an x-axis. In other words, the V_{G} used as the x-axis variable for the transfer curve is normalized by subtracting the charge neutrality point voltage V_{CNP} from the measured gate voltage e.g., V_{Ref}.

This makes the differences in shape and slope of the transfer curves easier to see graphically but it also separates a predominant biologically sensitive parameter from the characterization parameter encoder which means less predominant biologically sensitive parameters may now be encoded with more analytical efficiency.

FIG. 5C is an illustration of chart 530 with a further reduced complexity form of the I-V_{G} curves for FIGS. 5A and/or 5B, where the transfer curves are normalized to represent current as a percentage of maximum current along a y-axis and FIG. 5D is chart 540 with a resistance corrected version of the transfer curves that represent current as a percentage increase from the charge neutrality point along the y-axis.

However, as can be seen visually in the chart 540, certain aspects of the reduced complexity transfer curves in FIG. 5D are much easier to see with the normalized current resistance corrected version of the transfer curve.

For example, In FIG. 5B, it is not easy to see from chart 520 that the transconductance (slope in change of output current vs change in gate voltage) of the curve goes way up when the PBASE linker is added. However, after the complexity reduction module 126 has performed the y-axis normalization operations by determining a minimum value and a maximum value for each instance of channel output current a set of transfer curve information, subtracting the minimum value from each instance of channel output current in the set of transfer curve information, dividing each instance of channel output current in the set of transfer curve information by the maximum value minus the minimum value, and then performing a resistance correction by dividing by the resistance, the current is now expressed as a % increase from the charge neutrality point and the greater relative slope of PBASE is visible.

In order to make the curve fitting encoding performed by the machine learning that encodes the full set of elements in the vector 144 into the compress representation that is used to output the encoded output characterization parameters k A w and B, the complexity reduction module 126 takes the first derivative of the x and y normalized and/or resistance corrected transfer curve information 128.

FIG. 6A is an illustration of a chart 610 that models results of transfer curves in a reduced complexity form that is a normalized current version of a first derivative of the I-V_{G} curves for the normalized I-V_{G} curves depicted in FIG. 5C;

$$\frac{d I}{d {V}_{G}} = k {V}_{G} + B + \frac{A}{1 + {e}^{- w {V}_{G}}} \qquad \text{(601)}$$

In the depicted example, the equation 601 models the first derivative of the transfer curve using a linear term kV_{G}, a constant term B, and a logistic function term

$$\frac{A}{1 + {e}^{- w {V}_{G}}} ,$$

which is referred to herein as a logistic function term in which the numerator A is the maximum value of the logistic function term.

FIG. 6B is an illustration of a chart 620 that models results of transfer curves in a reduced complexity form that is a resistance corrected first derivative of the I-V_{G} curves for the normalized I-V_{G} curves depicted in FIG. 6A.

It may be noted that in the standard non-derivative form of the fit function represented by the equation 503 depicted by the transfer curves shown in chart 520 of FIG. 5B, although the curves are depicted as continuous curves, they are in reality merely data points that are fit to the normalized model represented by equation 503. In this form, since the lowest current value I_{DS} sampled is approaching an asymptote it might not be exact but it is the best estimate of the lowest drain current that can be obtained from the data set because it can be easily ascertained whether any of the other data points in the transfer curve vector has a lower current.

However, there could be a lower current point in between two sampled voltage reference voltage points and if so, that point of lowest current would be the Dirac voltage point or the charge neutrality point voltage V_{CNP}. So, since the transfer curve near the Dirac voltage has a parabolic form, one could determine whether the Dirac voltage fits the form of a quadratic term for the lowest current point C 148 and the points before and after C 148.

Fortunately, in one or more examples, this approach can be avoided by configuring the complexity reduction module 126 to determine the Dirac voltage (e.g., the charge neutrality point voltage) from the reduced complexity first derivative form of the fit function modeled by equation 601.

As can be seen in FIGS. 6A and 6B, at the x-axis = 0 point where V_{G} is normalized, the Dirac voltage V_{CNP} can be calculated as the place where the curve crosses the V_{G} = 0 axis. Although the sampling of the gate voltage might not occur precisely at the V_{G}=0 axis, in the first derivative form the fit function is not a parabola but a line by configuring the complexity reduction module 126 to determine the Dirac voltage by determining the equation of a line between the two voltage points of the first derivative transfer curve vector closest to opposite sides of the V_{G}=0 point and solving for the point at which the line crosses the V_{G} = 0 axis, the Dirac voltage V_{CNP} 150 can be quickly and easily determined by the complexity reduction module 126 as an non-encoded output characterization parameter 142 and the machine learning model 700 can avoid including the Dirac voltage V_{CNP} as an encoded output 146.

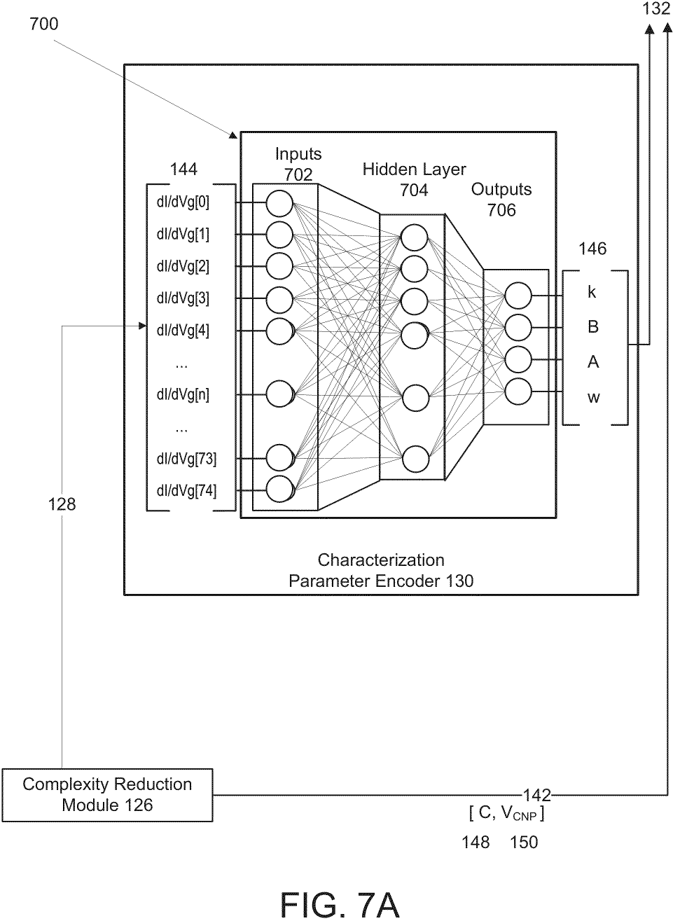

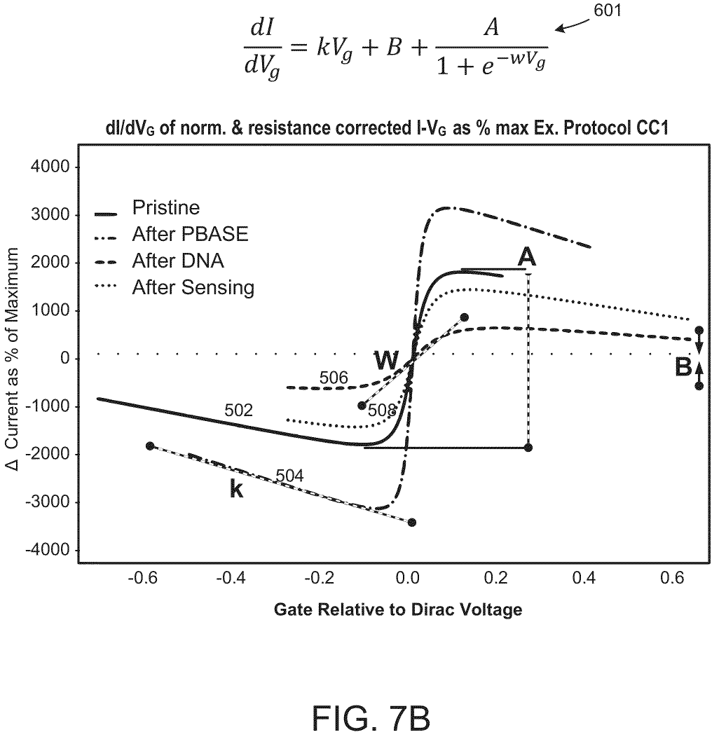

FIG. 7A is a schematic block diagram illustrating a machine learning model 700 for encoding and decoding analytically efficient output characterization parameters 132 from reduced complexity forms of 2D FET transfer curves.

A characterization parameter encoder 130 is included in various implementations in the apparatus 200 depicted in FIG. 2 and reproduced in part in FIG. 7A. The characterization parameter encoder 130 determines one or more output characterization parameters 132 as output data 706, 146 of a machine learning model 700 by applying the transfer curve information 128 for the 2D FETs 118 as input data 702 (e.g., vector 144) to the machine learning model 700, where the machine learning model 700 has been trained to produce as outputs 706 the one or more output characterization parameters 146 of the fit function that models the selected form of the transfer curve information for the 2D FETs, such as for example, the first derivative form of the transfer curve defined by equation 601. Although the first derivative form of the transfer curve defined by equation 601 has proven to be beneficial, other models that include output characterization parameters suitable to characterize the transfer curves in ways that provide meaningful insights about biochemical interactions may also be used instead of equation 601.

For example, transfer curve information in a form that fits a fit function that models a physical model, such as equation 750 below, may be processed or transformed by the complexity reduction module 126 and/or the characterization parameter encoder 130 to highlight other analytically efficient output characterization parameters.

The inventors of the present subject matter implemented a working example which has been shown to produce encoded output characterization parameters 146 that are highly analytically efficient. The encoded output characterization parameters produced by the machine learning model 700 are significantly analytically efficient based on several factors.

First, a machine learning model similar to the machine learning model 700 was implemented initially as an autoencoder. Then, the encoder part was saved to use as an encoder in a feed forward neural network with an input layer 702, hidden layer 704, and an output layer 706 that encodes the transfer curves and outputs selected parameters that fit the fit function that models that form of the transfer curves used to train the encoder.

By encoding hundreds of randomly select gFETs transfer curves having a fit function that models equation 503, the inventors of the present subjected determined that nearly all I-V_{G} transfer curves fit a model of a 2D FET device with a graphene channel described by a standard (non-first derivative) equation 503 described above and depicted in FIG. 5B. Although equation 503 is a five parameter form of the transfer curve model that includes the minimum output current parameter C which does not need to be encoded, encoding it did not affect the resulting reconstruction coefficient of determination R² meaning that of hundreds of randomly selected transfer curves selected as input vectors the encoder section of the autoencoder and the decoder section of the autoencoder worked well enough that none of the hundreds of TCs tested had any issues.

In equation 503, the complexity reduction module 126 has normalized the I-V_{G} curves at V_{G} = 0 by subtracting the value of V_{CNP} from each of the transfer curve voltage values V_{G} the fit function for the machine learning model to encode now becomes a five parameter function.

I is the channel current often referred to as I_{D} drain current or I_{DS} drain to source current. In graphene FETs, source and drain may sometimes be interchanged.

C is a minimum current.

B is a current offset of the curve related to skew.

A is a maximum current.

V_{CNP} is the voltage at the charge neutrality point.

This form of transfer curve information provided good starting values for several optimization type curve fitting algorithms to be used to generate training sets that can be used to train the machine learning model.

Two examples of suitable optimization models for generating training sets, validation sets, or test set of transfer curve include a Broyden-Fletcher-Goldfarb-Shanno (BFGS) algorithm or a Levenberg-Marquardt algorithm also known as the damped least-squares method fitting.

Although in various example, the machine learning model 700 can be trained with transfer curve information that is in a reduced complexity form (e.g., via normalization) but not in the form of a first derivative of the transfer curve, the inventors of the present subject matter determined that taking the first derivative dI/dV_{G} of the transfer curve would lower the order or degree of each term in equation 503 by one so that the first three terms which have the form a quadratic expression kV_{G}² + BV_{G} + C now are expressed as a slope intercept form of a line kV_{G} + B which is great because C did not need to be encoded any way.

When the first derivative is taken, the second half of equation 503, which is

$$\frac{A}{w} ln \left(1 + {e}^{w {V}_{G}}\right) ,$$

becomes a logistic function with a numerator

$$\frac{A}{1 + {e}^{- w {V}_{G}}} .$$

Thus, in such an example implementation, the machine learning model 700 used in the characterization parameter encoder 130 is trained to encode transfer curve vectors 144 input to the machine learning model where the fit function used to generate the training sets, the validation sets, and the test sets are all based on a model where the output characterization parameters indicates a biochemical interaction occurring within a measurement distance of the 2D FET based on one or more of:
a first output characterization parameter ‘k’ output by the machine learning model which corresponds to one or more slopes of p-type and n-type plateau regions of the sigmoid curve and varies based on total volume of biochemical material interacting with the channel of the 2D FET;
a third output characterization parameter ‘A’ output by the machine learning model which corresponds to a vertical scaling numerator of a logistic function term of the first derivative and varies based on ionic strength of the fluid containing the biochemical material; and
a fourth output characterization parameter ‘w’ output by the machine learning model which corresponds to the slope of logistic function exponential growth region and varies based on a total charge of the biochemical material interacting with the channel of the 2D FETs.

Additionally, the machine learning model 700 used in the characterization parameter encoder indicates a potential manufacturing anomaly in the 2D FET based on a second output characterization parameter ‘B’ output by the machine learning model which corresponds to a vertical offset in the derivative of a resistance adjusted change in currents.

The structure of the neural network with fewer neurons in the hidden layer 714 and the output layer 716 constrains the machine learning model to output those curve fitting coefficients which predominated whatever form of transfer curves were provides as input regardless of the diverse range of biochemical interactions occurring on the 2D FET while generating the hundreds of thousands of transfer curves used to train the machine learning model.

Once an autoencoder machine learning model is trained and verified to meet the goodness of fit requirements for reconstructing transfer curves produced by a training set of input training set vectors, the encoding portion of the autoencoder can be used in the machine learning model 700 that is trained to output the four first derivative output characterization parameters in response to new first derivative inputs vectors using the encoding captured in training.

In some examples, the vector 144 and vector elements used as inputs to train the machine learning model are a vector of first derivative (dI/dV_{G}) values generated via linear interpolation of the original data at prespecified gate voltage values covering the range of gate voltages at which data was acquired. Since high hysteresis at the ends of the gate voltage range may lead to anomalies at the ends of the transfer curve, data points from the middle of the transfer curve may be retained, and data points from the end portions of the transfer curves may be discarded. For example, with data points at 75 predetermined gate voltage values, the middle 60 data points may be retained. The input data may be standardized by subtracting the mean of the training set data and dividing by its variance.

In the depicted example, V_{G} is the measure gate voltage (V_{Ref}) minus the Dirac voltage (the gate voltage at which minimum current is observed) and k, B, A and w, are parameters whose values vary as external conditions change.

Transfer curves which exhibit a poor fit to this function have frequently been observed to result from chip defects, suggesting that the goodness of fit of this relationship for transfer curves acquired on a 2D FET (e.g., gFET) found in any of one or more sensor ICs 116, (116a, 116b, 116c, 116d) on any of one or more sensor nodes 114 (e.g., 114a, 114b, 114c, 114d) may be more easily detected by the B parameter associated with that particular 2D FET and can more quickly be replaced.

Various optimization methods may be used to determine parameters k, B, A, and w. An optimization algorithm may vary the parameter values to optimize a function that indicates how well the equation fits the data. For example, parameters may be varied to minimize the negative log likelihood of the data using the limited-memory Broyden-Fletcher-Goldfarb-Shanno (L-BGFS) algorithm or another local optimization algorithm. However, arrays of multiple 2D FETs, such as gFETs, on multiple sensor ICs or devices may produce hundreds or thousands of transfer curves, and may be repeatedly sampled over time. Optimization procedures like L-BFGS are relatively slow, so that determination of parameter values for each transfer curve incurs considerable computational expense. The expense may be greatly reduced by training machine learning model to predict the correct values of the four parameters that would be obtained from a fit instead.

In various examples, a machine learning model may be trained on a dataset that includes transfer curve information associated with parameters determined by an optimization algorithm. To implement this approach, optimization algorithms may be used to generate a training data set of parameters for transfer curve first derivatives, and the parameters determined by optimization may be associated with the raw transfer data to train the machine learning model and/or evaluate its performance. The machine learning model may be trained to predict what parameters would be produced by an optimization algorithm, so that parameters for transfer curves outside the training data set may be determined by machine learning prediction rather than by direct application of the optimization algorithm.

A characterization parameter encoder 130, by applying a trained machine learning model, may determine the set of parameters faster than by using an optimization algorithm. Using machine learning instead of optimization-based curve-fitting may allow multiple distributed sensor nodes 114 to provide real-time results locally, or to send a set of parameters that summarize the transfer curve information back to a storage nodes 104, in addition to or instead of the raw transfer curve information.

In one example of training the machine learning model 700, a dataset of 294,421 transfer curves (e.g., raw transfer curve information from 2D FETs, such as gFETs) are assembled to produce a training data set. The complexity reduction module 126 normalizes the transfer curves in the data set by subtracting the Dirac voltage V_{CNP} for each curve from measured gate voltage values (V_{Ref}) for that curve and the four-parameter equation 601 for all of the transfer curve elements is individually fitted to each transfer curve vector using a Limited-memory Broyden-Fletcher-Goldfarb-Shann (L-BFGS) optimization algorithm to obtain optimal first derivative output characterization parameter values for that curve. Transfer curves with a poor fit (e.g., with R^2 < 0.9975 for the fit) may be excluded to train the model on curves where the four parameter fit is an appropriate approximation of the data.

The remaining 250,450 transfer curves were randomly assigned to a training set, a validation set and a test set comprising 175,315 curves, 25,045 curves and 50,090 curves respectively. The source drain current measured by the device is a function both of external conditions (analyte binding to immobilized receptors, buffer type and ionic strength etc.) and the applied gate voltage. In order to ensure that the machine learning model is trained to encode output characterization parameters that are analytically efficient, the training sets included thousands of transfer curves from a predetermined range of representative surface chemistries and target biomolecules, buffer types, ionic strengths, and so forth. Also, sensor ICs with and without known defects were included to assess the sensitivity of the output characterization parameters to certain manufacturing issues,

The inputs to the machine learning model are dI/dV_{G} values generated via linear interpolation of the original data at 75 prespecified gate voltage values covering the range of gate voltages at which data was acquired. Since high hysteresis at the ends of the gate voltage range may lead to anomalies at the ends of the transfer curve, the middle 60 datapoints were retained. The input data is standardized by subtracting the mean of the training set data and dividing by its variance. With the training dataset completed, one example of machine learning training includes training a 3-layer fully connected neural network implemented using the open source PyTorch library in Python using gated linear unit activation and batch normalization to predict the four parameter values obtained by the L-BFGS fit, using the dI/dV_{G} values as input using the adaptive moment estimation or Adam optimization algorithm until convergence (40 epochs).

FIG. 7B is an annotated version of the illustration depicted in FIG. 7A showing four output characterization parameters labeled on the resistance adjusted first derivative form of the transfer curves;

In the example implementation, a first output characterization parameter ‘k’ output by the machine learning model 700 corresponds to one or more slopes of p-type and n-type plateau regions of the sigmoid curve and varies based on total volume of biochemical material interacting with the channel of the 2D FET.

A third output characterization parameter ‘A’ output by the machine learning model 700 corresponds to a vertical scaling numerator of a logistic function term of the first derivative and varies based on ionic strength of the fluid containing the biochemical material.

A fourth output characterization parameter ‘w’ output by the machine learning model corresponds to the slope of logistic function exponential growth region and varies based on a total charge of the biochemical material interacting with the channel of the 2D FETs.

A second output characterization parameter ‘B’ output by the machine learning model corresponds to a vertical offset in the derivative of a resistance adjusted change in currents.

Adjustments to model structure are evaluated using performance on the validation set; the test set is set aside and used to assess the performance of the final trained selected model. Results on the test set met predetermined goodness of fit criteria (e.g., R^2 > 0.991 for all four parameters) suggest the machine learning model provided good predictions for transfer curves where the four parameter fit is a reasonable approximation, at a large reduction in computational expense compared with L-BFGS - based fitting.

In some examples, generating a training dataset using optimization methods may be computationally expensive, and training the machine learning model may also be computationally expensive, but implementing the trained machine learning model may be less computationally intensive. Thus, in some examples, a machine learning model may be centrally trained, and implemented on analysis modules of multiple distributed sensor node 114, to provide local or distributed analysis of transfer curves. Once optimization has been used to generate a training dataset, the analysis module may apply the machine learning model to determine transfer curve parameters for transfer curves outside the training data, without applying an optimization algorithm to the transfer curve information from the measurement controller.

In some examples, because the distributed sensor nodes 114 determine transfer curve parameters without computationally expensive or slow optimization methods, the measurement controller 122 may repeatedly redetermine transfer curve information for a sensor IC 116, and the analysis module may repeatedly redetermine the set of parameters in real time, so that an elapsed time to redetermine the set of parameters is less than or equal to an elapsed time to redetermine the transfer curve information. By using machine learning to determine transfer curve parameters faster than the next transfer curve is measured, changes to transfer curves and parameters may be analyzed and communicated or displayed as they happen. In contrast, optimization methods that determine transfer curve parameters in more time than it takes to gather a transfer curve may result in analysis being delayed to a considerably later time than data gathering, moved to a central location with more computing power, or the like.

For routine determination of transfer curve parameters, a characterization parameter encoder 130 may preprocess transfer curve information in a way that parallels how the transfer curve information was processed for the training data set. For example, the analysis module may interpolate the transfer curve information to generate values for the first derivative of the transfer curve at predetermined gate voltage values, as input to the machine learning model. Similarly, the analysis module may retain the interpolated values from a middle portion of a gate voltage range as input to the machine learning model, and discard the interpolated values from one or more end portions of the gate voltage range.

As a more specific example, in one implementation, input transfer curves from a measurement controller may be interpolated using simple linear interpolation to obtain dI/dV_{G} values at 75 prespecified values for V_{G} across the gate voltage range covered by the data. Since values at the ends are frequently unreliable due to high hysteresis, the 60 points in the middle are kept and are supplied as input to the machine learning model, which predicts the four parameter values that would provide a good fit. These four parameter values can then be used as a compact description of the transfer curve to assess how changes in external conditions are shifting or changing the shape of the curve.

The insights gained from these examples helped them develop a more comprehensive physical model with relevant parameters such as the mobility, gate capacitance, and charge density of the graphene biosensor may be extracted from the transfer curve values. The more comprehensive physical model is an expression for the current related to the applied voltages and physical parameters. One example of an improved physical model is set forth in equation 750 below.

$$\begin{matrix}I = \\ \frac{1}{{R}_{C N P}} {V}_{D S} \sqrt{\left(1 + s k e w \left(\frac{\left|{V}_{G} - {V}_{C N P}\right|}{2 \left(V G\right) - {V}_{C N P}} - \frac{1}{2}\right) \left({C}_{C N P} + {V}_{V G} {\left({V}_{G} - {V}_{C N P}\right)}^{2}\right)\right) {\left({V}_{G} - {V}_{C N P}\right)}^{2} + 1}\end{matrix} \qquad \text{(750)}$$

In the model of equation

$$750 , \frac{1}{{R}_{C N P}} = \frac{2 q μ W {n}_{0}}{L} \text{} \text{and} n * ∝ \frac{{C}_{C N P}}{{C}_{V G}} .$$

This model gives the current (I) for the transistor width (W), length (L), capacitance (C_{CNP}), mobility (µ), total carrier density (n₀), effective charge density (n*), applied drain-source voltage (V_{DS}), applied gate voltage (V_{G}), charge neutrality voltage (V_{CNP}), the charge constant (q), skew between N and P branches, and the correction to the capacitance and mobility due to the gate voltage away from the charge neutrality point (C_{VG}).

Apparatus, systems, and methods related to this physical model and applications for its use are described in US application 18/174,418 filed Feb. 24, 2023, and is titled “Integrated Circuit Chip With 2D Field-Effect Transistors And On-Chip Thin Layer Deposition With Electrical Characterization.”

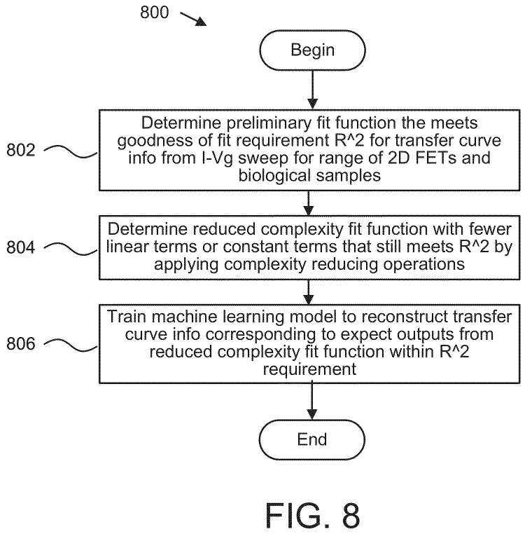

FIG. 8 is a schematic flow chart diagram illustrating a method 800 for determining a machine learning model with a minimized number of output characterization parameters useful for characterizing differences in biochemical interactions occurring in a fluid within a measurement distance of an array of 2D FETs on a sensor IC.

In one example implementation, the method 800 begins and includes determining 802 a preliminary fit function that satisfies a predetermined goodness of fit requirement for a set of transfer curve information obtained by applying bias conditions including a drain-to-source voltage and a gate-to-source voltage to the 2D FET, and measuring drain currents for the 2D FET while varying the gate-to-source voltage of the 2D FET, where instances of transfer curve information are obtained for a range of respective 2D FETs and a range of respective biological samples applied to the 2D FET. In various examples, the method 800 continues and includes determining 804 a reduced complexity fit function that has fewer linear terms or constants terms than the preliminary fit function by applying one or more complexity reducing operations to the transfer curve information in the set in response to determining that applying the one or more operations continues to satisfy the predetermined goodness of fit requirement. In some implementation, the method 800 continues and includes training 806 a machine learning model to reconstruct transfer curve information that corresponds to expected outputs from the reduced complexity fit function for the transfer curve information within a predetermined reconstruction coefficient of determination.

In various examples, the method 800 may be implemented using the system 100, the apparatuses 200, and 700 and various components thereof. For example, one or more steps of the method 800 may be implemented by the complexity reduction module 126 and/or the characterization parameter encoder 130 depicted in and described with respect to FIGS. 1, 2, and 7.

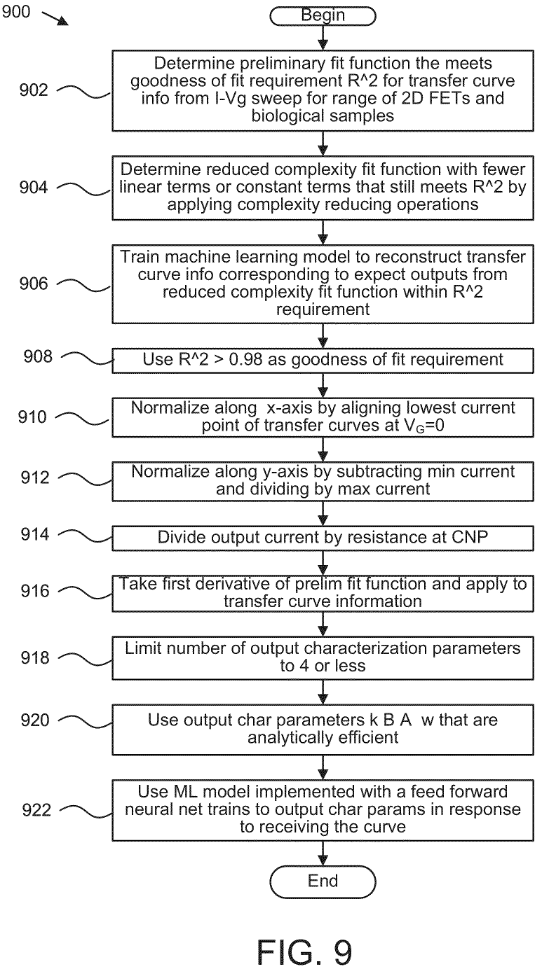

FIG. 9 is a schematic flow chart diagram illustrating a method 900 with further details for training a machine learning model to output characterization parameters that model a reduced complexity fit function for a range of 2D FET transfer curves, according to one or more examples of the present disclosure.

The method 900 begins and includes acts 902, 904, 906 which are substantially the same as acts 802, 804 and 806 described above with respect to the method 800 depicted in FIG. 8.

The method 900 continues and in some examples of the method 900, the predetermined coefficient of determination is 0.98 or greater. In certain example, the method 900 continues and includes one or more complexity reducing operations selected from preparing 910 normalized transfer curve information along an x-axis representing gate voltage by subtracting a charge neutrality point voltage from a gate voltage for the transfer curves to align lowest points of the transfer curves at a V_{G}=0 point along an x-axis; preparing 912 normalized transfer curve information along a y-axis representing channel output current to be within a range of from 0 to 1 by: determining a minimum value and a maximum value for each instance of channel output current in the set of transfer curve information, subtracting the minimum value from each instance of channel output current in the set of transfer curve information, and dividing each instance of channel output current in the set of transfer curve information by the maximum value minus the minimum value; dividing 914 each instance of channel output current in the set of transfer curve information by resistance at the charge neutrality point; and combinations thereof.

In certain examples, the method 900 includes determining 918 a first derivative of the preliminary fit function; and applying the first derivative of the preliminary fit function to the normalized transfer curve information.

In some examples of the method 900 the minimized number of output characterized parameters for the machine learning model is four or less.

In various implementation examples of the method 900, the output characterization parameters of the machine learning model correspond one or more parameters of a first derivative of a normalized fit function a first output characterization parameter ‘k’ represents a slope of a coefficient of in a linear term of the first derivative that combines with output of a logistic growth function and varies based on total volume of biochemical material interacting with the channel of the 2D FETs; a second output characterization parameter ‘B’ includes a constant term of the first derivative that varies with manufacturing variation of the 2D FETs; third output characterization parameter ‘A’ includes a numerator of a logistic function term of the first derivative and varies based on ionic strength of the fluid containing the biochemical material; a fourth output characterization parameter w includes a logistic growth rate of the logistic function term varies based on a total charge of the biochemical material interacting with the channel of the 2D FETs.

In certain implementation examples of the method 900, the machine learning model includes a feed forward neural network encoder that is trained to output the one or more output characterization parameters of the reduced complexity fit function for the transfer within a predetermined reconstruction coefficient of determination in response to receiving the 2D FET transfer curve information.

In various examples, the method 900 may be implemented using the system 100, the apparatuses 200, and 700 and various components thereof. For example, one or more steps of the method 900 may be implemented by the complexity reduction module 126 and/or the characterization parameter encoder 130 depicted in and described with respect to FIGS. 1, 2, and 7.

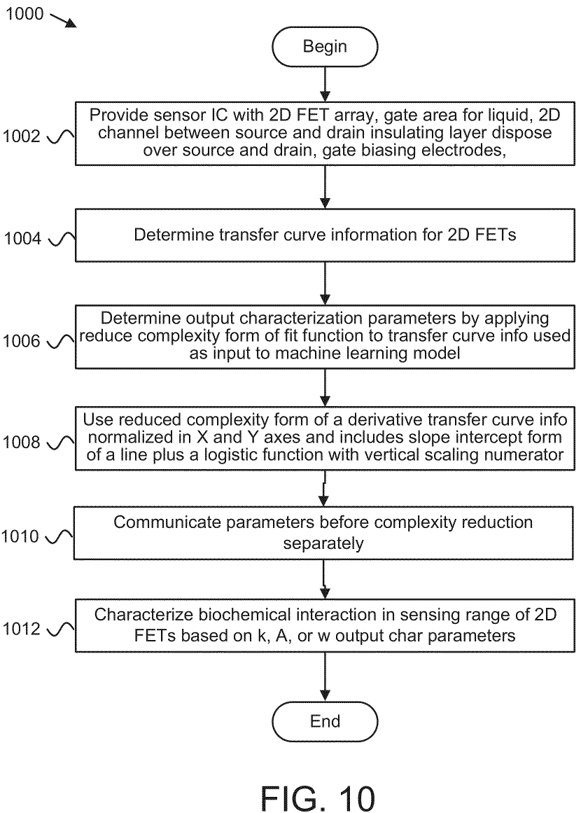

FIG. 10 is a schematic flow chart diagram illustrating a method 1000 for determining analytically efficient transfer curve parameters, according to one or more examples of the present disclosure.

In certain implementations, the method 1000 includes providing 1002 an IC including; a sensor array of 2D FETs, each 2D FET in the array including a 2D transistor channel formed in a layer of 2D nanomaterial disposed on a substrate; a gate area for receiving a volume of liquid; a conductive source electrically coupled to a first end of the 2D transistor channel; a conductive drain electrically coupled to a second end of the 2D transistor channel and an insulating layer disposed over the conductive source and the conductive drain; one or more integrated gate biasing electrodes disposed on the substrate for biasing and/or measuring electrical characteristics of the liquid over gate areas of the array. Although some of the method of the present disclosure may be applied to 2D nanomaterials other than graphene and/or two biosensors that include only one integrated biasing electrode, it may be noted that when used with graphene FETs and both counter electrodes and reference electrodes the sensitivity and accuracy are remarkably good.

In one or more implementations, the method 1000 continues and includes determining 1004 transfer curve information for the 2D FETs of the array by applying bias conditions including a drain-to-source voltage and a gate-to-source voltage, and measuring channel currents for the 2D FETs while varying the gate-to-source voltage. In some implementations, the step of determining 1004 transfer curve information may include both applying bias conditions to liquid in a gate area via a counter electrode with cycles of a forward voltage sweep (e.g., ramping V_{GS} from -0.5 V 1.0 V) and a backward voltage (e.g., ramping V_{GS} from 1.0 V to -0.5 V). However, in various applications, the inventors have found that forward sweeps are sufficient to provide good analytical results.

In certain applications the method 1000 continues and includes determining 1006 one or more output characterization parameters as output data of a machine learning model by applying a reduced complexity form of a fit function that models transfer curves of the 2D FETs to transfer curve information used as input data to the machine learning model, where the machine learning model has been trained to output the one or more output characterization parameters of the reduced complexity form of the fit function in response to receive the 2D FET transfer curve information as input data.

As explained above with respect to FIGS. 1, 2, 5A-5D, and 7, although the machine learning model is capable of being trained to encode parameters for transfer curves with a form that has not been reduced in complexity, encoding parameters without intelligently extracting parameters that occur only once per transfer curve cycle or that are easily determined without using curve fitting techniques increases the computational complexity of the problem and requirements of the machine learning model but also increases the risk that the output characteristic parameters may have a lower analytical efficiency.

For example, to validate this hypothesis, the inventors of the present subject matter performed a machine learning experiment using general curve fitting techniques with polynomial-based curve fitting in which the degree of the polynomial variable and the coefficients were in the standard general form and were unrelated to the physical model of the 2D FETs. The output parameters generated by the machine learning model had very low analytical efficiency meaning that correlations between coefficients output by the machine learning model and known characteristics of the biochemical interactions of target substance and the 2D FETs were not apparent.

In some examples, the method 1000 uses 1008 a reduced complexity form of the transfer curve information modeled by the machine learning model that includes a first derivative of the transfer curve normalized along x and y axes and including a slope intercept form of a line plus a logistic function with a vertical scaling numerator.

In certain examples the method 1000 includes 1010 characterizing a biochemical interaction occurring within a measurement distance of the 2D FETs based on one or more of: a first output characterization parameter ‘k’ output by the machine learning model which corresponds to one or more slopes of plateau regions of a logistic function including a sigmoid curve and varies based on total volume of biochemical material interacting with the channel of the 2D FET; a third output characterization parameter ‘A’ output by the machine learning model which corresponds to a vertical scaling numerator of a logistic function term of the first derivative and varies based on the ionic strength of the fluid containing the biochemical material; and a fourth output characterization parameter ‘w’ output by the machine learning model which corresponds to the slope of logistic function exponential growth region and varies based on the total charge of the biochemical material interacting with the channel of the 2D FETs.

In various examples, the method 1000 may be implemented using the system 100, the apparatus 200 and various components thereof. For example, one or more steps of the method 1000 may be implemented by the complexity reduction module 126 and/or the characterization parameter encoder 130 depicted in and described with respect to FIGS. 1 and 2.

As noted above, one of the benefits of using the machine learning approach is that apparatuses and methods set forth in the present disclosure with an intelligent approach to reducing the complexity of the transfer curve input is augment and help separate incomplete knowledge of the overall device physics of 2D FET from incomplete knowledge of biochemistry and molecular biology. While 2D FETs are reaching a phase where they have predictable responses, biological components are emergent from an evolutionary process and it is extraordinarily difficult to predict specific responses to particular binding interactions. However, through the machine learning structures and processes disclosed herein, a scalable model for sensor IC and binding agent combinations with certain unknown parameters may be obtained using sufficient training sets of data. Furthermore, by deriving inventive machine learning models that capitalize on material and structural insights with, more sensitive physical models for BPUs and other sensors based on 2D materials have been developed as described above and may be further refined.

Various example implementations of present disclosure are described in the following clauses:

Clause 1. An apparatus for determining one or more output characterization parameters of a fit function that models a selected form of transfer curves for an array of 2D field effect transistors (FETs) on a sensor IC for characterizing biochemical interactions occurring within a measurement distance of the 2D FETs, the apparatus comprising: a memory storing transfer curve information for the 2D FETs obtained by applying bias conditions including a drain-to-source voltage and a gate-to-source voltage to the 2D FETs, and measuring channel currents for the 2D FETs while varying the gate-to-source voltage of the 2D FETs; and a characterization parameter encoder that determines the one or more output characterization parameters as output data of a machine learning model by applying the transfer curve information for the 2D FETs as input data to the machine learning model, wherein the machine learning model has been trained to produce as outputs the one or more output characterization parameters of the fit function that models the selected form of the transfer curve information for the 2D FETs.

Clause 2. The apparatus of clause 1, wherein the transfer curve information comprises a set of data points that associate a set of channel output currents of the 2D FETs measured in response to one or more excitation conditions comprising a voltage sweep of liquid gate bias voltage applied to a fluid covering the 2D FETs.

Clause 3. The apparatus of clause 1, wherein the machine learning model comprises a feed forward neural network encoder that has been trained to determine a fit function comprising four or less output characterization parameters curve based on training set data comprising the transfer curve information that model a form of the transfer curves for the 2D FETs.

Clause 4. The apparatus of clause 1, wherein the transfer curve information comprises one or more vectors comprising elements corresponding to 2D FET excitation conditions varied in accordance with a predetermined incrementally varying voltage sweep of a liquid gate bias voltage, and/or a 2D channel input bias voltage varied at a predetermined characteristic resonance frequencies; and further comprising output elements corresponding to 2D FET output signals generated in response to the 2D FET excitation conditions and to biochemical interactions occurring in the liquid.

Clause 5. The apparatus of clause 1, further comprising a complexity reduction module that produces a reduced complexity form of the transfer curve information by applying one or more operations to the transfer curve information in response to determining that applying the one or more operations continues to satisfy a predetermined goodness of fit requirement.

Clause 6. The apparatus of clause 5, wherein the predetermined goodness of fit requirement is satisfied in response to values output from the machine learning model fitting actual values with a coefficient of determination of 0.98 or greater.

Clause 7. The apparatus of clause 5, wherein the one or more operations applied by the complexity reduction module are selected from: normalized transfer curve information along an x-axis representing a gate voltage VG by subtracting a charge neutrality point voltage from a measured value VRef of a gate voltage for the transfer curves to align lowest points of the transfer curves at a VG=0 point along an x-axis; normalized transfer curve information along a y-axis representing channel output current to be within a range of from 0 to 1 by determining a minimum value and a maximum value for each instance of channel output current in a set of transfer curve information, subtracting the minimum value from each instance of channel output current in the set of transfer curve information, dividing each instance of channel output current in the set of transfer curve information by the maximum value minus the minimum value; a first derivative of the transfer curve model normalized along x and y axes and comprising a slope intercept form of a line plus a logistic function with a sigmoid curve and a vertical scaling numerator; a resistance corrected version thereof; and combinations thereof.

Clause 8. The apparatus of clause 7, wherein the characterization parameter encoder indicates a biochemical interaction occurring within a measurement distance of the 2D FET based on one or more of: a first output characterization parameter ‘k’ output by the machine learning model which corresponds to one or more slopes of p-type and n-type plateau regions of the sigmoid curve and varies based on total volume of biochemical material interacting with the channel of the 2D FET; a third output characterization parameter ‘A’ output by the machine learning model which corresponds to a vertical scaling numerator of a logistic function term of the first derivative and varies based on ionic strength of a liquid containing the biochemical material; and a fourth output characterization parameter ‘w’ output by the machine learning model which corresponds to the slope of logistic function exponential growth region and varies based on a total charge of the biochemical material interacting with the channel of the 2D FETs.

Clause 9. The apparatus of clause 7, wherein the characterization parameter encoder indicates a potential manufacturing anomaly in the 2D FET based on a second output characterization parameter ‘B’ output by the machine learning model which corresponds to a vertical offset in the derivative of a resistance adjusted change in currents.

Clause 10. A method for determining a machine learning model with a minimized number of output characterization parameters useful for characterizing differences in biochemical interactions occurring in a fluid within a measurement distance of an array of 2D FETs on a sensor IC, the method comprising: determining a preliminary fit function that satisfies a predetermined goodness of fit requirement for a set of transfer curve information obtained by applying bias conditions including a drain-to-source voltage and a gate-to-source voltage to the 2D FET, and measuring drain currents for the 2D FET while varying the gate-to-source voltage of the 2D FET, wherein instances of transfer curve information are obtained for a range of respective 2D FETs and a range of respective biological samples applied to the 2D FET; determining a reduced complexity fit function that has fewer linear terms or constants terms than the preliminary fit function by applying one or more complexity reducing operations to the transfer curve information in the set in response to determining that applying the one or more operations continues to satisfy the predetermined goodness of fit requirement; and training a machine learning model to reconstruct transfer curve information that corresponds to expected outputs from the reduced complexity fit function for the transfer curve information within a predetermined reconstruction coefficient of determination.

Clause 11. The method of clause 10, wherein the predetermined coefficient of determination is 0.98 or greater.

Clause 12. The method of clause 10, wherein the one or more complexity reducing operations comprise: preparing normalized transfer curve information along an x-axis representing gate voltage by subtracting a charge neutrality point voltage from a gate voltage for the transfer curves to align lowest points of the transfer curves at a VG=0 point along an x-axis; preparing normalized transfer curve information along a y-axis representing channel output current to be within a range of from 0 to 1 by: determining a minimum value and a maximum value for each instance of channel output current in the set of transfer curve information, subtracting the minimum value from each instance of channel output current in the set of transfer curve information, and dividing each instance of channel output current in the set of transfer curve information by the maximum value minus the minimum value; dividing each instance of channel output current in the set of transfer curve information by resistance at the charge neutrality point; and combinations thereof.

Clause 13. The method of clause 12, wherein the one or more operations further comprise: determining a first derivative of the preliminary fit function; and applying the first derivative of the preliminary fit function to the normalized transfer curve information.

Clause 14. The method of clause 13, wherein the minimized number of output characterized parameters for the machine learning model is four or less.

Clause 15. The method of clause 13, wherein: wherein the output characterization parameters of the machine learning model correspond one or more parameters of a first derivative of a normalized fit function a first output characterization parameter ‘k’ represents a slope of a coefficient of in a linear term of the first derivative that combines with output of a logistic growth function and varies based on total volume of biochemical material interacting with the channel of the 2D FETs; a second output characterization parameter ‘B’ comprises a constant term of the first derivative that varies with manufacturing variation of the 2D FETs; third output characterization parameter ‘A’ comprises a numerator of a logistic function term of the first derivative and varies based on ionic strength of the fluid containing the biochemical material; and a fourth output characterization parameter w comprises a logistic growth rate of the logistic function term varies based on a total charge of the biochemical material interacting with the channel of the 2D FETs.

Clause 16. The method of clause 15, wherein the machine learning model comprises a feed forward neural network encoder that is trained to output the one or more output characterization parameters of the reduced complexity fit function for the transfer within a predetermined reconstruction coefficient of determination in response to receiving the 2D FET transfer curve information.

Clause 17. A method comprising: providing an integrated circuit (“IC”) comprising; a sensor array of two-dimensional (“2D”) field effect transistors (“2D FETs”), each 2D FET in the array comprising: a 2D transistor channel formed in a layer of 2D nanomaterial disposed on a substrate; a gate area for receiving a volume of liquid; a conductive source electrically coupled to a first end of the 2D transistor channel; a conductive drain electrically coupled to a second end of the 2D transistor channel; and an insulating layer disposed over the conductive source and the conductive drain; one or more integrated gate biasing electrodes disposed on the substrate for biasing and/or measuring electrical characteristics of the liquid over gate areas of the array; and determining transfer curve information for the 2D FETs of the array by applying bias conditions including a drain-to-source voltage and a gate-to-source voltage, and measuring channel currents for the 2D FETs while varying the gate-to-source voltage; and determining one or more output characterization parameters as output data of a machine learning model by applying a reduced complexity form of a fit function that models transfer curves of the 2D FETs to transfer curve information used as input data to the machine learning model, wherein the machine learning model has been trained to output the one or more output characterization parameters of the reduced complexity form of the fit function in response to receive the 2D FET transfer curve information as input data.

Clause 18. The method of clause 17, wherein the reduced complexity form of the transfer curve information modeled by the machine learning model comprises a first derivative of the transfer curve normalized along x and y axes and comprising a slope intercept form of a line plus a logistic function with a vertical scaling numerator.

Clause 19. The method of clause 18, further comprising characterizing a biochemical interaction occurring within a measurement distance of the 2D FETs based on one or more of: a first output characterization parameter ‘k’ output by the machine learning model which corresponds to one or more slopes of plateau regions of a logistic function comprising a sigmoid curve and varies based on total volume of biochemical material interacting with the channel of the 2D FET; a third output characterization parameter ‘A’ output by the machine learning model which corresponds to a vertical scaling numerator of a logistic function term of a first derivative and varies based on an ionic strength of the liquid containing the biochemical material; and a fourth output characterization parameter ‘w’ output by the machine learning model which corresponds to the slope of logistic function exponential growth region and varies based on a total charge of the biochemical material interacting with the channel of the 2D FETs.

Clause 20. A system comprising: a data repository; and a plurality of distributed sensor nodes, each sensor node comprising: an integrated circuit (“IC”) comprising; a sensor array of two-dimensional field effect transistors (“2D FETs”), each 2D FET in the array comprising: a 2D transistor channel formed in a layer of 2D material disposed on a substrate; a gate area for receiving a volume of liquid; a conductive source electrically coupled to a first end of the 2D transistor channel; a conductive drain electrically coupled to a second end of the 2D transistor channel; and an insulating layer disposed over the conductive source and the conductive drain; one or more integrated gate biasing electrodes disposed on the substrate for biasing and/or measuring electrical characteristics of the liquid over gate areas of the array; a measurement controller operable to determine transfer curve information for the 2D FETs of the array by applying bias conditions including a drain-to-source voltage and a gate-to-source voltage, and measuring drain currents for the 2D FETs while varying the gate-to-source voltage; and a characterization parameter encoder operable to determine a set of output characterization parameters for an equation that models a first derivative of a transfer curve, by applying a machine learning model to the transfer curve information from the measurement controller, wherein the machine learning model is trained to associate transfer curve information with parameters.

Examples may be practiced in other specific forms. The described examples are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus for determining one or more output characterization parameters of a fit function that models a selected form of transfer curves for an array of 2D field effect transistors (FETs) on a sensor IC for characterizing biochemical interactions occurring within a measurement distance of the 2D FETs, the apparatus comprising:
a memory storing transfer curve information for the 2D FETs obtained by applying bias conditions including a drain-to-source voltage and a gate-to-source voltage to the 2D FETs, and measuring channel currents for the 2D FETs while varying the gate-to-source voltage of the 2D FETs; and
a characterization parameter encoder that determines the one or more output characterization parameters as output data of a machine learning model by applying the transfer curve information for the 2D FETs as input data to the machine learning model, wherein the machine learning model has been trained to produce as outputs the one or more output characterization parameters of the fit function that models the selected form of the transfer curve information for the 2D FETs.

2. The apparatus of claim 1, wherein the transfer curve information comprises a set of data points that associate a set of channel output currents of the 2D FETs measured in response to one or more excitation conditions comprising a voltage sweep of liquid gate bias voltage applied to a fluid covering the 2D FETs.

3. The apparatus of claim 1, wherein the machine learning model comprises a feed forward neural network encoder that has been trained to determine a fit function comprising four or less output characterization parameters curve based on training set data comprising the transfer curve information that model a form of the transfer curves for the 2D FETs.

4. The apparatus of claim 1, wherein the transfer curve information comprises one or more vectors comprising elements corresponding to 2D FET excitation conditions varied in accordance with a predetermined incrementally varying voltage sweep of a liquid gate bias voltage, and/or a 2D channel input bias voltage varied at a predetermined characteristic resonance frequencies; and further comprising output elements corresponding to 2D FET output signals generated in response to the 2D FET excitation conditions and to biochemical interactions occurring in the liquid.

5. The apparatus of claim 1, further comprising a complexity reduction module that produces a reduced complexity form of the transfer curve information by applying one or more operations to the transfer curve information in response to determining that applying the one or more operations continues to satisfy a predetermined goodness of fit requirement.

6. The apparatus of claim 5, wherein the predetermined goodness of fit requirement is satisfied in response to values output from the machine learning model fitting actual values with a coefficient of determination of 0.98 or greater.

7. The apparatus of claim 5, wherein the one or more operations applied by the complexity reduction module are selected from:
normalized transfer curve information along an x-axis representing a gate voltage V_{G} by subtracting a charge neutrality point voltage from a measured value V_{Ref} of a gate voltage for the transfer curves to align lowest points of the transfer curves at a V_{G}=0 point along an x-axis;
normalized transfer curve information along a y-axis representing channel output current to be within a range of from 0 to 1 by determining a minimum value and a maximum value for each instance of channel output current in a set of transfer curve information, subtracting the minimum value from each instance of channel output current in the set of transfer curve information, dividing each instance of channel output current in the set of transfer curve information by the maximum value minus the minimum value;
a first derivative of the transfer curve model normalized along x and y axes and comprising a slope intercept form of a line plus a logistic function with a sigmoid curve and a vertical scaling numerator;
a resistance corrected version thereof; and
combinations thereof.

8. The apparatus of claim 7, wherein the characterization parameter encoder indicates a biochemical interaction occurring within a measurement distance of the 2D FET based on one or more of:
a first output characterization parameter ‘k’ output by the machine learning model which corresponds to one or more slopes of p-type and n-type plateau regions of the sigmoid curve and varies based on total volume of biochemical material interacting with the channel of the 2D FET;
a third output characterization parameter ‘A’ output by the machine learning model which corresponds to a vertical scaling numerator of a logistic function term of the first derivative and varies based on ionic strength of a liquid containing the biochemical material; and
a fourth output characterization parameter ‘w’ output by the machine learning model which corresponds to the slope of logistic function exponential growth region and varies based on a total charge of the biochemical material interacting with the channel of the 2D FETs.

9. The apparatus of claim 7, wherein the characterization parameter encoder indicates a potential manufacturing anomaly in the 2D FET based on a second output characterization parameter ‘B’ output by the machine learning model which corresponds to a vertical offset in the derivative of a resistance adjusted change in currents.

10. A method for determining a machine learning model with a minimized number of output characterization parameters useful for characterizing differences in biochemical interactions occurring in a fluid within a measurement distance of an array of 2D FETs on a sensor IC, the method comprising:
determining a preliminary fit function that satisfies a predetermined goodness of fit requirement for a set of transfer curve information obtained by applying bias conditions including a drain-to-source voltage and a gate-to-source voltage to the 2D FET, and measuring drain currents for the 2D FET while varying the gate-to-source voltage of the 2D FET, wherein instances of transfer curve information are obtained for a range of respective 2D FETs and a range of respective biological samples applied to the 2D FET;
determining a reduced complexity fit function that has fewer linear terms or constants terms than the preliminary fit function by applying one or more complexity reducing operations to the transfer curve information in the set in response to determining that applying the one or more operations continues to satisfy the predetermined goodness of fit requirement; and
training a machine learning model to reconstruct transfer curve information that corresponds to expected outputs from the reduced complexity fit function for the transfer curve information within a predetermined reconstruction coefficient of determination.

11. The method of claim 10, wherein the predetermined coefficient of determination is 0.98 or greater.

12. The method of claim 10, wherein the one or more complexity reducing operations comprise:
preparing normalized transfer curve information along an x-axis representing gate voltage by subtracting a charge neutrality point voltage from a gate voltage for the transfer curves to align lowest points of the transfer curves at a V_{G}=0 point along an x-axis;
preparing normalized transfer curve information along a y-axis representing channel output current to be within a range of from 0 to 1 by:
determining a minimum value and a maximum value for each instance of channel output current in the set of transfer curve information,
subtracting the minimum value from each instance of channel output current in the set of transfer curve information, and
dividing each instance of channel output current in the set of transfer curve information by the maximum value minus the minimum value;
dividing each instance of channel output current in the set of transfer curve information by resistance at the charge neutrality point; and
combinations thereof.

13. The method of claim 12, wherein the one or more operations further comprise:
determining a first derivative of the preliminary fit function; and
applying the first derivative of the preliminary fit function to the normalized transfer curve information.

14. The method of claim 13, wherein the minimized number of output characterized parameters for the machine learning model is four or less.

15. The method of claim 13, wherein:
wherein the output characterization parameters of the machine learning model correspond one or more parameters of a first derivative of a normalized fit function
a first output characterization parameter ‘k’ represents a slope of a coefficient of in a linear term of the first derivative that combines with output of a logistic growth function and varies based on total volume of biochemical material interacting with the channel of the 2D FETs;
a second output characterization parameter ‘B’ comprises a constant term of the first derivative that varies with manufacturing variation of the 2D FETs;
third output characterization parameter ‘A’ comprises a numerator of a logistic function term of the first derivative and varies based on ionic strength of the fluid containing the biochemical material; and
a fourth output characterization parameter w comprises a logistic growth rate of the logistic function term varies based on a total charge of the biochemical material interacting with the channel of the 2D FETs.

16. The method of claim 15, wherein the machine learning model comprises a feed forward neural network encoder that is trained to output the one or more output characterization parameters of the reduced complexity fit function for the transfer within a predetermined reconstruction coefficient of determination in response to receiving the 2D FET transfer curve information.

17. A method comprising:
providing an integrated circuit (“IC”) comprising;
a sensor array of two-dimensional (“2D”) field effect transistors (“2D
FETs″), each 2D FET in the array comprising:
a 2D transistor channel formed in a layer of 2D nanomaterial disposed on a substrate;
a gate area for receiving a volume of liquid;
a conductive source electrically coupled to a first end of the 2D transistor channel;
a conductive drain electrically coupled to a second end of the 2D transistor channel; and
an insulating layer disposed over the conductive source and the conductive drain;
one or more integrated gate biasing electrodes disposed on the substrate for biasing and/or measuring electrical characteristics of the liquid over gate areas of the array; and
determining transfer curve information for the 2D FETs of the array by applying bias conditions including a drain-to-source voltage and a gate-to-source voltage, and measuring channel currents for the 2D FETs while varying the gate-to-source voltage; and
determining one or more output characterization parameters as output data of a machine learning model by applying a reduced complexity form of a fit function that models transfer curves of the 2D FETs to transfer curve information used as input data to the machine learning model, wherein the machine learning model has been trained to output the one or more output characterization parameters of the reduced complexity form of the fit function in response to receive the 2D FET transfer curve information as input data.

18. The method of claim 17, wherein the reduced complexity form of the transfer curve information modeled by the machine learning model comprises a first derivative of the transfer curve normalized along x and y axes and comprising a slope intercept form of a line plus a logistic function with a vertical scaling numerator.

19. The method of claim 18, further comprising characterizing a biochemical interaction occurring within a measurement distance of the 2D FETs based on one or more of:
a first output characterization parameter ‘k’ output by the machine learning model which corresponds to one or more slopes of plateau regions of a logistic function comprising a sigmoid curve and varies based on total volume of biochemical material interacting with the channel of the 2D FET;
a third output characterization parameter ‘A’ output by the machine learning model which corresponds to a vertical scaling numerator of a logistic function term of a first derivative and varies based on an ionic strength of the liquid containing the biochemical material; and
a fourth output characterization parameter ‘w’ output by the machine learning model which corresponds to the slope of logistic function exponential growth region and varies based on a total charge of the biochemical material interacting with the channel of the 2D FETs.

20. A system comprising:
a data repository; and
a plurality of distributed sensor nodes, each sensor node comprising:
an integrated circuit (“IC”) comprising;
a sensor array of two-dimensional field effect transistors (“2D FETs”), each 2D FET in the array comprising:
a 2D transistor channel formed in a layer of 2D material disposed on a substrate;
a gate area for receiving a volume of liquid;
a conductive source electrically coupled to a first end of the 2D transistor channel;
a conductive drain electrically coupled to a second end of the 2D transistor channel; and
an insulating layer disposed over the conductive source and the conductive drain;
one or more integrated gate biasing electrodes disposed on the substrate for biasing and/or measuring electrical characteristics of the liquid over gate areas of the array;
a measurement controller operable to determine transfer curve information for the 2D FETs of the array by applying bias conditions including a drain-to-source voltage and a gate-to-source voltage, and measuring drain currents for the 2D FETs while varying the gate-to-source voltage; and
a characterization parameter encoder operable to determine a set of output characterization parameters for an equation that models a first derivative of a transfer curve, by applying a machine learning model to the transfer curve information from the measurement controller, wherein the machine learning model is trained to associate transfer curve information with parameters.
